(19) United States
(12) Patent Application Publication
(10) Pub. No.: US 2010/0236887 A1
(43) Pub. Date: Sep. 23, 2010

(54) HYDRAULIC PRESSURE CONTROL APPARATUS FOR HYDRAULIC POWER TRANSMISSION

(75) Inventor: Osamu SAKAMOTO, Handa-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/720,047

(22) Filed: Mar. 9, 2010

(30) Foreign Application Priority Data
Mar. 23, 2009 (JP) 2009-070600

(51) Int. Cl. F16D 33/08

(52) U.S. Cl. 192/3.3; 192/3.29

(57) ABSTRACT

A hydraulic pressure control apparatus for a hydraulic power transmission, which includes a pump impeller, a turbine runner, and a multi-plate impeller clutch, the multi-plate impeller clutch configured to engage the pump impeller to a power source by supplying a hydraulic pressure to a hydraulic pressure chamber. The apparatus further includes a control valve for controlling the hydraulic pressure to be supplied to the hydraulic pressure chamber, a fail valve disposed between the hydraulic pressure chamber and the control valve for selectively connecting the hydraulic pressure chamber and the control valve or the hydraulic pressure chamber and a source of a hydraulic pressure, and an electronic control portion controlling operations of the control valve and the fail valve. The hydraulic pressure chamber is connected to the source of the hydraulic pressure when at least one of the control valve, the fail valve, and the electronic control portion fails.

### CROSS REFERENCE TO RELATED APPLICATIONS

This application is based on and claims priority under 35 U.S.C. §119 to Japanese Patent Application 2009-070600, filed on Mar. 23, 2009, the entire content of which is incorporated herein by reference.

### TECHNICAL FIELD

This disclosure relates to a hydraulic pressure control apparatus for a hydraulic power transmission for controlling a hydraulic pressure applied to an engaging element of the hydraulic power transmission. More particularly, this disclosure pertains to a hydraulic pressure control apparatus for a hydraulic power transmission having a mechanism for disconnecting a pump impeller from a power source.

### BACKGROUND DISCUSSION

Automatic transmissions include a hydraulic power transmission having, on a torque delivery path between a power source and a transmission, a fluid coupling or a torque converter which is configured to transmit a torque of the power source continuously from a stall state to a directly connected state of an output shaft of the power source and an input shaft of the transmission. A known hydraulic power transmission includes a lock-up clutch which directly connects (physically links) a pump impeller and a turbine runner to eliminate a rotational speed difference therebetween when a rotational speed difference between the pump impeller and the turbine runner is small in order to enhance fuel economy during an operation of a vehicle. The lock-up clutch is controlled to be engaged or disengaged by a hydraulic pressure control of the hydraulic pressure control apparatus. The lock-up clutch may be a single plate clutch type which performs engagement and disengagement operations by a hydraulic pressure for transmitting a torque by means of fluid using two fluid passages or may be a multi-plate clutch type which operates by supplying a hydraulic pressure for engagement which is different from the hydraulic pressure for transmitting the torque by means of the fluid using three fluid passages (e.g., JP2003-42287A, referred to as Patent Reference 1 hereinafter).

Further, known hydraulic power transmissions disclose a mechanism which is configured to disconnect a pump impeller from a power source (i.e., hereinafter referred to as an impeller clutch) in order to reduce fluid resistance between the turbine runner and the pump impeller in order to reduce the fuel consumption during an idling of an engine (see for example, JP2000-346135A and JP2004-301327A (US2004/0216971A) referred to as Patent reference 2 and Patent reference 3, respectively).

A hydraulic pressure circuit disclosed in Patent reference 1 may be applied to a hydraulic power transmission having an impeller clutch disclosed in Patent reference 2 or Patent reference 3 in order to control an engagement or disengagement of the impeller clutch.

However, with the hydraulic pressure circuit disclosed in Patent reference 1, the lock-up clutch may not be engaged in case of a trouble, for example, a failure of a solenoid valve, an adhering of a control valve, and an adhering of a relay valve, or the like. Thus, with the construction that the hydraulic pressure circuit, for example, disclosed in Patent reference 1 is applied to the hydraulic power transmission having the impeller clutch, for example, disclosed in Patent reference 2 or 3, in a case where a trouble occurs in the hydraulic pressure circuit, the impeller clutch may not be engaged. That the impeller clutch cannot be engaged connotes that there is a risk that the power may not be sufficiently transmitted to the pump impeller.

A need thus exists for a hydraulic pressure control apparatus for a hydraulic power transmission which is not susceptible to the drawback mentioned above.

### SUMMARY

In light of the foregoing, the disclosure provides a hydraulic pressure control apparatus for a hydraulic power transmission, which includes the hydraulic power transmission including a pump impeller configured to rotate, a turbine runner configured to rotate receiving an operational fluid provided from the rotating pump impeller, and a multi-plate impeller clutch configured to disconnect the pump impeller from a power source, the multi-plate impeller clutch configured to engage the pump impeller to the power source by supplying a hydraulic pressure to a hydraulic pressure chamber. The hydraulic pressure control apparatus further includes a control valve for controlling a level of the hydraulic pressure to be supplied to the hydraulic pressure chamber, a fail valve disposed between the hydraulic pressure chamber and the control valve, the fail valve for selectively connecting the hydraulic pressure chamber and the control valve or the hydraulic pressure chamber and a source of a hydraulic pressure, and an electronic control portion controlling operations of the control valve and the fail valve. The hydraulic pressure chamber is connected to the source of the hydraulic pressure when at least one of the control valve, the fail valve, and the electronic control portion fails.

According to another aspect, a hydraulic pressure control apparatus for a hydraulic power transmission includes the hydraulic power transmission which includes a pump impeller configured to rotate, a turbine runner configured to rotate receiving an operational fluid provided from the rotating pump impeller, and a single-plate impeller clutch for disconnecting the pump impeller from a power source, the single-plate impeller clutch configured to engage the pump impeller to the power source when a hydraulic pressure in a hydraulic pressure chamber is smaller than a predetermined level. The hydraulic pressure control apparatus further includes a control valve for controlling a level of the hydraulic pressure to be supplied to the hydraulic pressure chamber, a fail valve disposed between the hydraulic pressure chamber and the control valve, the fail valve selectively connecting the hydraulic pressure chamber and the control valve or the hydraulic pressure chamber and a discharge passage, and an electronic control portion controlling operations of the control valve and the fail valve. The hydraulic pressure chamber is connected to the discharge passage when at least one of the control valve, the fail valve, and the electronic control portion fails.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view of a hydraulic pressure control apparatus for a hydraulic power transmission according to a first embodiment disclosed here;

FIG. 2 is a schematic view of a hydraulic pressure control apparatus for a hydraulic power transmission according to a second embodiment disclosed here;

FIG. 3 is a schematic view of a hydraulic pressure control apparatus for a hydraulic power transmission according to a third embodiment disclosed here;

FIG. 4 is a schematic view of a hydraulic pressure control apparatus for a hydraulic power transmission according to a fourth embodiment disclosed here;

FIG. 5 is a schematic view of a hydraulic pressure control apparatus for a hydraulic power transmission according to a fifth embodiment disclosed here;

FIG. 6 is a schematic view of a hydraulic pressure control apparatus for a hydraulic power transmission according to a sixth embodiment disclosed here;

FIG. 7 is a schematic view of a hydraulic pressure control apparatus for a hydraulic power transmission according to a seventh embodiment disclosed here;

FIG. 8 is a schematic view of a hydraulic pressure control apparatus for a hydraulic power transmission according to an eighth embodiment disclosed here;

FIG. 9A is a schematic view of a modified example of a torque converter having a single-plate type lock-up clutch and a multi-plate type impeller clutch, which is applicable to a hydraulic pressure control apparatus for a hydraulic power transmission according to a ninth embodiment disclosed here; and

FIG. 9B is a schematic view of a modified example of a torque converter having a single-plate type lock-up clutch and a single-plate type impeller clutch, which is applicable to a hydraulic pressure control apparatus for a hydraulic power transmission according to the ninth embodiment disclosed here.

### DETAILED DESCRIPTION

Embodiments of a hydraulic pressure control apparatus for a hydraulic power transmission will be explained with reference to illustrations of drawing figures as follows.

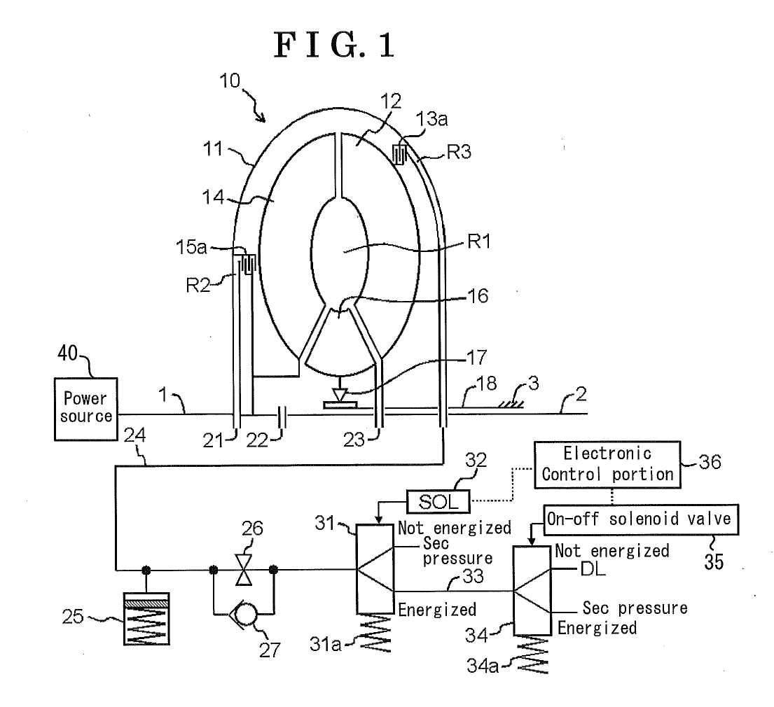

According to a hydraulic pressure control apparatus for a hydraulic power transmission of a first embodiment, a turbine runner (see 14 in FIG. 1) is rotated receiving an operational fluid (oil) outputted from a rotated pump impeller (see 12 in FIG. 1) and a multi-plate type impeller clutch (see 13a in FIG. 1), which is configured to disconnect the pump impeller from a power source, is engaged by supplying a hydraulic pressure to a hydraulic pressure chamber (see R3 in FIG. 1). The hydraulic pressure control apparatus for the hydraulic power transmission further includes a control valve (see 34 in FIG. 1) controlling a hydraulic pressure supplied to the hydraulic pressure chamber, a fail valve (see 31 in FIG. 1) disposed on a fluid path (see 24 and 33 in FIG. 1) between the hydraulic pressure chamber and the control valve and configured to selectively connect between the hydraulic pressure chamber and the control valve or a hydraulic pressure supply source (see Sec pressure in FIG. 1), and an electronic control portion (see 36 in FIG. 1) controlling operations of the control valve and the fail valve. The hydraulic pressure chamber is configured to be connected to the hydraulic pressure supply source when at least one of the control valve, the fail valve, and the electronic control portion fails.

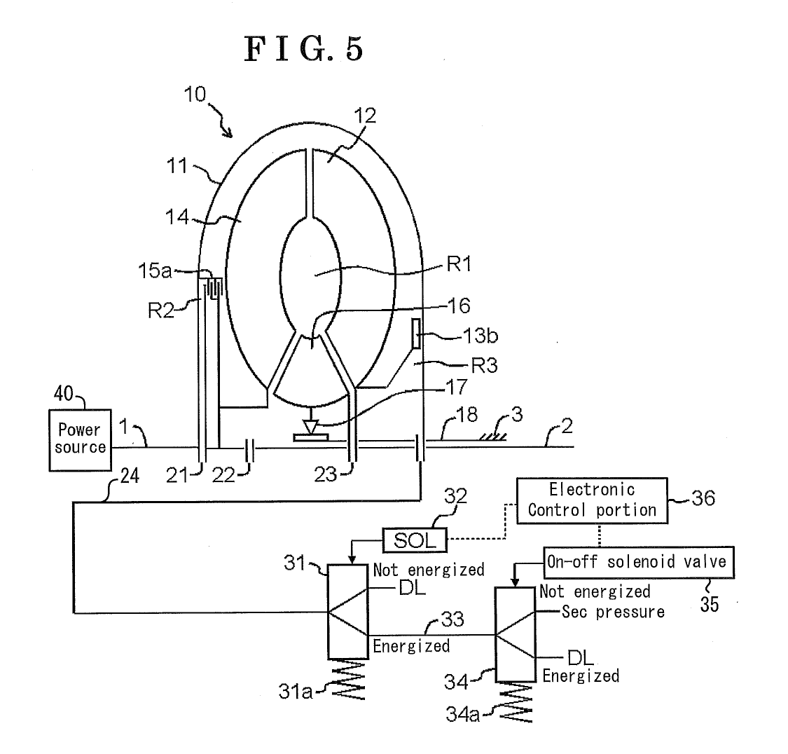

According to a hydraulic pressure control apparatus for a hydraulic power transmission of a fifth embodiment, a turbine runner (see 14 in FIG. 5) is rotated receiving an operational fluid (oil) outputted from a rotating pump impeller (see 12 in FIG. 5) and a single-plate type impeller clutch (see 13b in FIG. 5), which is configured to disconnect the pump impeller from a power source, is engaged by not supplying a hydraulic pressure to a hydraulic pressure chamber (see R3 in FIG. 5). The hydraulic pressure control apparatus for the hydraulic power transmission further includes a control valve (see 34 in FIG. 5) controlling a hydraulic pressure supplied to the hydraulic pressure chamber, a fail valve (see 31 in FIG. 5) disposed on a fluid path (see 24 and 33 in FIG. 5) between the hydraulic pressure chamber and the control valve and configured to selectively connect between the hydraulic pressure chamber and the control valve or a discharge fluid path (see DL in FIG. 5), and an electronic control portion (see 36 in FIG. 5) controlling operations of the control valve and the fail valve. The hydraulic pressure chamber is configured to be connected to the discharge fluid path when at least one of the control valve, the fail valve, and the electronic control portion fails.

The hydraulic pressure control apparatus for the hydraulic power transmission according to the first embodiment will be explained in more details referring to FIG. 1 as follows. A hydraulic pressure circuit related to the impeller clutch is disclosed in FIG. 1.

The hydraulic pressure control apparatus for the hydraulic power transmission of the first embodiment shown in FIG. 1 corresponds to a hydraulic pressure control apparatus for a torque converter 10 which includes a multi-plate type impeller clutch 13a configured to disconnect a pump impeller 12 from a converter shell 11 integrally rotating with a power source (e.g., engine) 40. The hydraulic pressure control apparatus controls a hydraulic pressure supplied to the impeller clutch 13a to engage the impeller clutch 13a to establish an engaging state by supplying the hydraulic pressure and to disengage the impeller clutch 13a by not supplying the hydraulic pressure. The hydraulic pressure control apparatus, with respect to the impeller clutch 13a, includes an impeller clutch fluid passage 24, an accumulator 25, an orifice 26, a ball check valve 27, a fail valve 31, an on-off solenoid valve 32, a fluid passage 33, an impeller clutch control valve 34, an on-off solenoid valve 35, an electronic control portion 36, a hydraulic power transmission chamber R1, a lock-up clutch hydraulic pressure chamber R2, and an impeller clutch hydraulic pressure chamber R3.

The torque converter 10 is a hydraulic power transmission which generates torque multiplication by a rotational speed difference between the pump impeller 12 provided at an input side and a turbine runner 14 provided at an output side by applying hydrodynamic action. The torque converter 10 is disposed on a torque delivery path (power transmission path?) between an output shaft 1 for the power source 40 and an input shaft 2 for a transmission. The torque converter 10 includes the converter shell 11, the pump impeller 12, the impeller clutch 13a, the turbine runner 14, a lock-up clutch 15a, a stator 16, a one-way clutch 17, and a stator shaft 18.

The converter shell 11 serves as a casing for the torque converter 10. The converter shell 11 always integrally rotates with the output shaft 1 of the power source 40. Components of the torque converter 10 and an operational fluid are provided within the converter shell 11. The converter shell 11 is configured to relatively rotate to the pump impeller 12 and to rotate integrally with the pump impeller 12 when the lock up clutch 15a is engaged thereto. The converter shell 11 is configured to relatively rotate to the turbine runner 14 and to rotate integrally with the turbine runner 14 when the impeller clutch 13a is engaged thereto.

The pump impeller 12 is an impeller which rotates to send the operational fluid to the turbine runner 14. The pump impeller 12 is configured to rotate relatively to the converter shell 11 and to integrally rotate with the converter shell 11 when the impeller clutch 13a is engaged.

The impeller clutch 13a is a multi-plate clutch mechanism configured to disconnect the pump impeller 12 from the power source (e.g., engine) 40 in order to reduce the fluid resistance between the turbine runner 14 and the pump impeller 12 so that the fuel consumption during an idling of the engine is reduced. The impeller clutch 13a transmits a rotational force of the converter shell 11 to the pump impeller 12 when engaged. The impeller clutch 13a includes an input side clutch plate which is connected to the converter shell 11 not to be relatively rotatable but to be movable in an axial direction, and an output side clutch plate which is connected to the pump impeller 12 not to be relatively rotatable but to be movable in an axial direction, and a piston which is pushed out when a hydraulic pressure is supplied to the impeller clutch hydraulic pressure chamber R3. The input side clutch plates and the output side clutch plates are positioned alternately in the impeller clutch 13a, and the piston pushes the input side clutch plate and the output side clutch plate to frictionally engage the input side clutch plate and the output side clutch plate.

The turbine runner 14 is an impeller which rotates when receiving the operational fluid sent from the pump impeller 12. The turbine runner 14 always integrally rotates with the input shaft 2 of the transmission. The turbine runner 14 is configured to relatively rotate to the converter shell 11 and to integrally rotate with the converter shell 11 when the lock-up clutch 15a is engaged.

The lock-up clutch 15a is a multi-plate clutch mechanism which eliminates the rotational speed difference between the power source (e.g., engine) 40 and the turbine runner 14 by directly connecting the pump impeller 12 and the turbine runner 14 when the rotational speed difference between the pump impeller 12 and the turbine runner 14 is small. When the lock-up clutch 15a is engaged, torque of the converter shell 11 is transmitted to the turbine runner 14. The lock-up clutch 15a includes an input side clutch plate which is connected to the converter shell 11 not to be relatively rotatable but to be movable in an axial direction, an output side clutch plate connected to the turbine runner 14 not to be relatively rotatable but to be movable in an axial direction, and a piston which is pushed out by supplying the hydraulic pressure in the lock-up clutch hydraulic pressure chamber R2. The input side clutch plates and the output side clutch plates are positioned alternately in the lock-up clutch 15a, and the piston pushes the input side clutch plate and the output side clutch plate to frictionally engage the input side clutch plate and the output side clutch plate.

The stator 16 is disposed between the turbine runner 14 and the pump impeller 12 closer to an inner periphery and corresponds to an impeller which generates torque multiplication by adjusting and returning the operational fluid discharged from the turbine runner 14 to the pump impeller 12. The stator 16 is fixed to a transmission case 3 via the one-way clutch 17 and the stator shaft 18 and is configured to rotate only in one direction.

The one-way clutch 17 allows the stator 16 to rotate only in one direction. The stator 16 is fixed to a rotational end of the one-way clutch 17. A fixed end of the one-way clutch 17 is fixed to the transmission case 3 via the stator shaft 18.

The stator shaft 18 is a shaft member for fixing the fixed end of the one-way clutch 17 to the transmission case 3.

The hydraulic power transmission chamber R1 accommodates the pump impeller 12, the turbine runner 14, and the stator 16, and is filled with the operational fluid. The hydraulic pressure is supplied to the hydraulic power transmission chamber R1 via an inlet side fluid passage 22 and the hydraulic pressure is discharged from the hydraulic power transmission chamber R1 via an outlet side fluid passage 23.

The lock-up clutch hydraulic pressure chamber R2 is arranged for operating the lock-up clutch 15a. The lock-up clutch hydraulic pressure chamber R2 is connected to a lock-up clutch passage 21. In a case where a hydraulic pressure higher than a hydraulic pressure in the hydraulic power transmission chamber R1 is supplied to the lock-up clutch hydraulic pressure chamber R2, the lock-up clutch 15a is engaged, and the lock-up clutch 15a is released in a case where a hydraulic pressure in the lock-up clutch hydraulic pressure chamber R2 is lower than a hydraulic pressure in the hydraulic power transmission chamber R1.

The impeller clutch hydraulic pressure chamber R3 is arranged for operating the multi-plate impeller clutch 13a. The impeller clutch hydraulic pressure chamber R3 is connected to the impeller clutch fluid passage 24. In a case where a hydraulic pressure higher than a hydraulic pressure in the hydraulic power transmission chamber R1 is supplied to the impeller clutch hydraulic pressure chamber R3, the impeller clutch 13a is engaged, and the impeller clutch 13a is released in a case where a hydraulic pressure in the impeller clutch hydraulic pressure chamber R3 is lower than a hydraulic pressure in the hydraulic power transmission chamber R1.

The impeller clutch fluid passage 24 connects the impeller clutch hydraulic pressure chamber R3 and the fail valve 31. The impeller clutch fluid passage 24 is connected to the accumulator 25. The orifice 26 and the ball check valve 27 are arranged in parallel to each other on the impeller clutch fluid passage 24 at a position closer to the fail valve 31 relative to the accumulator 25.

The accumulator 25 accumulates a hydraulic pressure of the impeller clutch fluid passage 24. The accumulator 25 is connected to the impeller clutch fluid passage 24 at a position closer to the impeller clutch hydraulic pressure chamber R3 relative to the orifice 26 and the ball check valve 27. Whether connecting the accumulator 25 to the impeller clutch fluid passage 24 is optional.

The orifice 26 controls a flow amount of the operational fluid in the impeller clutch fluid passage 24. The orifice 26 is arranged in parallel to the ball check valve 27 on the impeller clutch fluid passage 24. Whether providing the orifice on the impeller clutch fluid passage 24 is optional.

The ball check valve 27 is a one-way valve which allows the hydraulic pressure at the impeller clutch hydraulic pressure chamber R3 to flow to the fail valve 31 and does not allow the hydraulic pressure at the fail valve 31 to flow to the impeller clutch hydraulic pressure chamber R3. The ball check valve 27 is disposed in parallel to the orifice 26 on the impeller clutch fluid passage 24. Whether providing the ball check valve 27 on the impeller clutch fluid passage 24 is optional.

The fail valve 31 is configured to selectively connect the impeller clutch fluid passage 24 to a supply source of a secondary pressure (Sec pressure) or the impeller clutch control valve 34. The fail valve 31 includes a valve body, a spool slidably provided in the valve body, and a spring 31a biasing the spool towards a control hydraulic chamber. The control hydraulic chamber is connected to the on-off solenoid valve 32. The fail valve 31 connects the impeller clutch fluid passage 24 and the impeller clutch control valve 34 so that the pressure is adjustable when a hydraulic pressure greater than a biasing force of the spring 31a is supplied from the on-off solenoid valve 32 to the control hydraulic chamber (i.e., when the on-off solenoid valve 32 is energized and the spring 31a is compressed). The fail valve 31 connects the impeller clutch fluid passage 24 and the source of the secondary pressure (Sec pressure) when a hydraulic pressure is not supplied from the on-off solenoid valve 32 to the control hydraulic chamber (i.e., when the on-off solenoid valve 32 is not energized and the spring 31a is expanded). Here, the secondary pressure (Sec pressure) corresponds to a hydraulic pressure which is adjusted by reducing the hydraulic pressure outputted from an oil pump (i.e., line pressure).

The on-off solenoid valve 32 controls whether or not to supply the hydraulic pressure to the control hydraulic chamber of the fail valve 31. The on-off solenoid valve 32 is a normally low solenoid valve which outputs the hydraulic pressure when energized and which does not output the hydraulic pressure when not energized. The on-off solenoid valve 32 is controlled by the electronic control portion 36. In place of the on-off solenoid valve 32, a linear solenoid valve which adjust a hydraulic pressure in accordance with a level of an electric current may be applied.

The fluid passage 33 connects the fail valve 31 and the impeller clutch control valve 34.

The impeller clutch control valve 34 is configured to connect the fluid passage 33 and the supply source of the secondary pressure (Sec pressure) or a discharge circuit DL. The impeller clutch control valve 34 includes a valve body, a spool slidably provided in the valve body, and a spring 34a biasing the spool towards a control hydraulic chamber. The control hydraulic chamber is connected to the on-off solenoid valve 35. The impeller clutch control valve 34 connects the fluid passage 33 and the supply source of the secondary pressure (Sec pressure) when a hydraulic pressure greater than a biasing force of the spring 34a is supplied from the on-off solenoid valve 35 to the control hydraulic chamber (i.e., when the on-off solenoid valve 35 is energized and the spring 34a is compressed). The impeller clutch control valve 34 connects the fluid passage 33 and the discharge circuit DL when a hydraulic pressure is not supplied from the on-off solenoid valve 35 to the control hydraulic chamber (i.e., when the on-off solenoid valve 35 is not energized and the spring 34a is expanded).

The on-off solenoid valve 35 controls whether or not to supply the hydraulic pressure to the control hydraulic chamber of the impeller clutch control valve 34. The on-off solenoid valve 35 is a normally low solenoid valve which outputs the hydraulic pressure when energized and which does not output the hydraulic pressure when not energized. The on-off solenoid valve 35 is controlled by the electronic control portion 36. According to the embodiment, the normally low solenoid valve is applied as the on-off solenoid valve 35, however, a normally high solenoid valve may also be applied.

The electronic control portion 36 is a computer which controls an operation of the on-off solenoid valve 32 and the on-off solenoid valve 35. The electronic control portion 36 performs information processing based on a predetermined program (i.e., including a data base, a map, or the like). The electronic control portion 36 performs information processing in accordance with signals sent from various sensors of a vehicle. The electronic control portion 36 judges whether the engine is idling or not, and controls the impeller clutch 13a to be disengaged in order to reduce the fluid resistance between the turbine runner 14 and the pump impeller 12 when the engine is idling. Control operation of the electronic control portion 36 will be explained in more details hereinafter.

A normal control operation of the electronic control portion of the hydraulic pressure control apparatus for the hydraulic power transmission according to the first embodiment will be explained as follows.

In a case where the engine is idling, the electronic control portion 36 connects the impeller clutch fluid passage 24 and the fluid passage 33 by controlling the on-off solenoid valve 32 to supply the hydraulic pressure to the control hydraulic chamber of the fail valve 31 (i.e., controlling the on-off solenoid valve 32 to be energized), and by controlling the on-off solenoid valve 35 not to supply the hydraulic pressure to the control hydraulic chamber of the impeller clutch control valve 34 (i.e., controlling the on-off solenoid valve 35 not to be energized) the electronic control portion 36 connects the fluid passage 33 and the discharge circuit DL so that the hydraulic pressure in the impeller clutch hydraulic pressure chamber R3 is discharged from the discharge circuit DL via the impeller clutch fluid passage 24, the fail valve 31, the fluid passage 33, and the impeller clutch control valve 34 to disengage the impeller clutch 13a.

On the other hand, when the engine is not idling, the electronic control portion 36 controls the on-off solenoid valve 32 to supply the hydraulic pressure to the control hydraulic chamber of the fail valve 31 (i.e., controls the on-off solenoid valve 32 to be energized) to connect the impeller clutch fluid passage 24 and the fluid passage 33, and controls the on-off solenoid valve 35 to supply the hydraulic pressure to the control hydraulic chamber of the impeller clutch control valve 34 (i.e., controls the on-off solenoid valve 35 to be energized) to connect the fluid passage 33 and the supply source of the secondary pressure (Sec pressure) so that the secondary pressure (Sec pressure) is supplied to the impeller clutch hydraulic pressure chamber R3 via the impeller clutch control valve 34, the fluid passage 33, the fail valve 31, and the impeller clutch fluid passage 24 to engage the impeller clutch 13a to establish the engaging state.

A control operation of the electronic control portion when a component of the hydraulic pressure control apparatus for the hydraulic power transmission according to the first embodiment fails will be explained hereinafter.

First, in a case where the on-off solenoid valve 32 fails in a state where the on-off solenoid valve 32 is controlled so as to output the hydraulic pressure, the spring 31a of the fail valve 31 is in a compressed state, which corresponds to the normal state that the fluid passage 33 and the impeller clutch fluid passage 24 are connected by the fail valve 31. Accordingly, the electronic control portion 36 enables to control the engagement or disengagement of the impeller clutch 13a by controlling the on-off solenoid valve 35 (i.e., by controlling the impeller clutch control valve 34), and thus a vehicle is operable by the control of the on-off solenoid valve 35 to establish the engaging state of the impeller clutch 13a.

Second, in a case where the on-off solenoid valve 32 fails in a state where the hydraulic pressure is not outputted (non-energized state), the spring 31a of the fail valve 31 is in an expanded state, and the fail valve 31 connects the supply source of the secondary pressure (Sec pressure) and the impeller clutch fluid passage 24. Accordingly, a control by the electronic control portion 36 cannot be performed. In other words, the electronic control portion 36 is not operational. However, because the secondary pressure (Sec pressure) is supplied to the impeller clutch hydraulic pressure chamber R3 via the fail valve 31 and the impeller clutch fluid passage 24 to engage the impeller clutch 13a to establish the engaging state, a vehicle is operable.

Third, in a case where the fail valve 31 fails (e.g., sticks) in a state where the spring 31a is compressed, similar to the first case, because the normal state where the fluid passage 33 and the impeller clutch fluid passage 24 are connected by the fail valve 31 is attained, the electronic control portion 36 enables to control the engagement and disengagement of the impeller clutch 13a by controlling the on-off solenoid valve 35 (i.e., controlling the impeller clutch control valve 34), and a vehicle is operable by the control of the on-off solenoid valve 35 to engage the impeller clutch 13a to establish the engaging state.

Fourth, in a case where the fail valve 31 fails in a state where the spring 31a is expanded, similar to the second case, because the fail valve 31 connects the secondary pressure (Sec pressure) and the impeller clutch fluid passage 24, a control by the electronic control portion 36 cannot be performed, in other words, the electronic control portion 36 is not operational. However, a vehicle is operable because the secondary pressure (Sec pressure) is supplied to the impeller clutch hydraulic pressure chamber R3 via the fail valve 31 and the impeller clutch fluid passage 24 to engage the impeller clutch 13a to establish the engaging state.

Fifth, in a case where the on-off solenoid valve 35 fails in a state where the hydraulic pressure is generated (energized state), because the impeller clutch control valve 34 continues to output the secondary pressure (Sec pressure), irrespective of the operation of the on-off solenoid valve 32 by the electronic control portion 36, the secondary pressure (Sec pressure) is provided to the impeller clutch fluid passage 24 via the fail valve 31. Thus, because the secondary pressure (Sec pressure) is supplied to the impeller clutch hydraulic pressure chamber R3 to engage the impeller clutch 13a to establish the engaging state, the vehicle is operable.

Sixth, in a case where the on-off solenoid valve 35 fails in a state where the on-off solenoid valve 35 does not generate the hydraulic pressure (non-energized state), the secondary pressure (Sec pressure) is not outputted via the impeller clutch control valve 34. When detecting the foregoing state, the electronic control portion 36 controls the on-off solenoid valve 32 connected to the fail valve 31 to be in a non-energized state. Accordingly, because the secondary pressure (Sec pressure) is supplied to the impeller clutch hydraulic pressure chamber R3 via the fail valve 31 and the impeller clutch fluid passage 24 to engage the impeller clutch 13a to establish the engaging state, the vehicle is operable.

Seventh, in a case where the impeller clutch control valve 34 fails in a state where the spring 34a is compressed, similar to the fifth case, because the impeller clutch control valve 34 continues to output the secondary pressure (Sec pressure), irrespective of the operation of the on-off solenoid valve 32 by the electronic control portion 36, the secondary pressure (Sec pressure) is provided to the impeller clutch fluid passage 24 via the fail valve 31. Thus, because the secondary pressure (Sec pressure) is supplied to the impeller clutch hydraulic pressure chamber R3 to engage the impeller clutch 13a to establish the engaging state, the vehicle is operable.

Eighth, in a case where the impeller clutch control valve 34 fails in a state where the spring 34a is expanded, similar to the sixth case, the secondary pressure (Sec pressure) is not outputted via the impeller clutch control valve 34. When detecting the foregoing state, the electronic control portion 36 controls the on-off solenoid valve 32 connected to the fail valve 31 to be in a non-energized state. Accordingly, because the secondary pressure (Sec pressure) is supplied to the impeller clutch hydraulic pressure chamber R3 via the fail valve 31 and the impeller clutch fluid passage 24 to engage the impeller clutch 13a to establish the engaging state, the vehicle is operable.

Ninth, in a case of a failure at which all electronic parts are in a non-energized state, for example, a power shut down of the electronic control portion 36, the on-off solenoid valve 32 connected to the fail valve 31 becomes a non-energized state so as not to output the hydraulic pressure, and the secondary pressure (Sec pressure) is supplied to the impeller clutch hydraulic pressure chamber R3 via the fail valve 31 and the impeller clutch fluid passage 24 to engage the impeller clutch 13a to establish the engaging state. Accordingly, the vehicle is operable.

According to the constructions of the first embodiment, because the impeller clutch 13a is securely engaged even if any components of the hydraulic pressure control apparatus fail, the vehicle is prevented from being inoperable, thus the safety of the vehicle is enhanced.

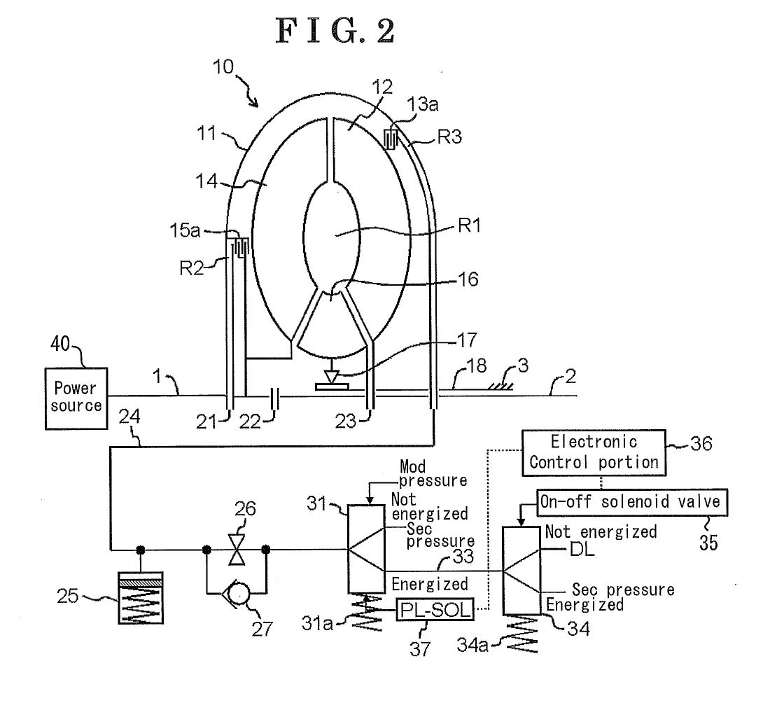

A hydraulic pressure control apparatus for a hydraulic power transmission according to a second embodiment will be explained with reference to FIG. 2. A hydraulic pressure circuit only with respect to an impeller clutch is shown in FIG. 2 for an explanatory purpose.

The second embodiment discloses a modified example of the hydraulic pressure circuit of the first embodiment, which includes the multi-plate impeller clutch 13a. According to the construction of the first embodiment, the on-off solenoid valve (see 32 in FIG. 1) is connected to the control hydraulic chamber of the fail valve (see 31 in FIG. 1) to switch the fluid paths of the fail valve (31 in FIG. 1) by controlling the hydraulic pressure of the on-off solenoid valve (32 in FIG. 1). On the other hand, according to constructions of the second embodiment, a supply source of a modulator pressure (Mod pressure) which has a constant hydraulic pressure is connected to the control hydraulic chamber of the fail valve 31, a line pressure linear solenoid valve 37 is connected to a spring chamber which houses the spring 31a of the fail valve 31, and fluid paths of the fail valve 31 are switched so that the impeller clutch fluid passage 24 is selectively connected to the supply source of the secondary pressure and the fluid passage 33 by controlling the hydraulic pressure of the line pressure linear solenoid valve 37. More particularly, a level of the hydraulic pressure of the line pressure linear solenoid valve 37 is controlled in accordance with an amount of energizing current supplied thereto and one of the fluid paths of the fail valve 31 is connected to the fluid passage 33 when the liner pressure linear solenoid valve 37 is energized and the other of the fluid paths of the fail valve 31 is connected to the supply source of the secondary pressure when not energized. Other constructions of the second embodiment are similar to the first embodiment. In those circumstances, the modulator pressure (Mod pressure) is defined by reducing a hydraulic pressure (line pressure) outputted from a fluid pump.

The fail valve 31 is configured to connect the impeller clutch fluid passage 24 with the supply source of the secondary pressure or the impeller clutch control valve 34. The fail valve 31 includes the valve body, the spool slidably provided in the valve body, and the spring 31a biasing the spool towards the control hydraulic chamber. The modulator pressure (Mod pressure) having a constant level of hydraulic pressure is introduced to the control hydraulic chamber. The line pressure linear solenoid valve 37 is connected to the spring chamber which houses the spring 31a. The fail valve 31 connects the impeller clutch fluid passage 24 and the impeller clutch control valve 34 so that the pressure is adjustable when the sum of a biasing force of the spring 31a and a hydraulic pressure of the line pressure linear solenoid valve 37 is less than the modulator pressure (Mod pressure) (i.e., when the line pressure linear solenoid valve 37 is energized and the spring 31a is compressed). The fail valve 31 connects the impeller clutch fluid passage 24 and the source of the secondary pressure (Sec pressure) when the sum of the biasing force of the spring 31a and the hydraulic pressure of the line pressure linear solenoid valve 37 is greater than the modulator pressure (Mod pressure) (i.e., when the line pressure linear solenoid valve 37 is not energized and the spring 31a is expanded).

The line pressure linear solenoid valve 37 is configured to control the hydraulic pressure supplied to the spring chamber of the fail valve 31 in accordance with a level of an electric current. The line pressure linear solenoid valve 37 is a normally high solenoid valve which either outputs a level of the hydraulic pressure defined by reducing the modulator pressure (Mod pressure) or does not output the hydraulic pressure when energized (in an energized state), and which outputs the modulator pressure (Mod pressure) when not energized (in a non-energized state). The line pressure linear solenoid valve 37 is controlled by the electronic control portion 36.

An operation of the electronic control portion of the hydraulic pressure control apparatus for the hydraulic power transmission according to the second embodiment in an energized state will be explained as follows.

In a case where the engine is idling, the electronic control portion 36 connects the impeller clutch fluid passage 24 and the fluid passage 33 by controlling the line pressure linear solenoid valve 37 not to supply the hydraulic pressure to the spring chamber of the fail valve 31 (i.e., controlling the line pressure linear solenoid valve 37 to be energized), and by controlling the on-off solenoid valve 35 not to supply the hydraulic pressure to the control hydraulic chamber of the impeller clutch control valve 34 (i.e., controlling the on-off solenoid valve 35 not to be energized) the electronic control portion 36 connects the fluid passage 33 and the discharge circuit DL so that the hydraulic pressure in the impeller clutch hydraulic pressure chamber R3 is discharged from the discharge circuit DL via the impeller clutch fluid passage 24, the fail valve 31, the fluid passage 33, and the impeller clutch control valve 34 to disengage the impeller clutch 13a to establish disengaging state.

On the other hand, when the engine is not idling, the electronic control portion 36 controls the line pressure linear solenoid valve 37 not to supply the hydraulic pressure to the spring chamber of the fail valve 31 (i.e., controls the line pressure linear solenoid valve 37 to be energized) to connect the impeller clutch fluid passage 24 and the fluid passage 33, and controls the on-off solenoid valve 35 to supply the hydraulic pressure to the control hydraulic chamber of the impeller clutch control valve 34 (i.e., controls the on-off solenoid valve 35 to be energized) to connect the fluid passage 33 and the supply source of the secondary pressure (Sec pressure) so that the secondary pressure (Sec pressure) is supplied to the impeller clutch hydraulic pressure chamber R3 via the impeller clutch control valve 34, the fluid passage 33, the fail valve 31, and the impeller clutch fluid passage 24 to engage the impeller clutch 13a to establish the engaging state.

A control operation of the electronic control portion when a component of the hydraulic pressure control apparatus for the hydraulic power transmission according to the second embodiment fails will be explained hereinafter.

First, in a case where the line pressure linear solenoid valve 37 fails in a state where the hydraulic pressure is outputted (non-energized state), the spring 31a of the fail valve 31 is in an expanded state, and the fail valve 31 connects the supply source of the secondary pressure (Sec pressure) and the impeller clutch fluid passage 24. Accordingly, a control by the electronic control portion 36 cannot be performed. In other words, the electronic control portion 36 is not operational. However, because the secondary pressure (Sec pressure) is supplied to the impeller clutch hydraulic pressure chamber R3 via the fail valve 31 and the impeller clutch fluid passage 24 to engage the impeller clutch 13a to establish the engaging state, a vehicle is operable.

Second, in a case where the line pressure linear solenoid valve 37 fails in a state where the line pressure linear solenoid valve is controlled so as not to output the hydraulic pressure, the spring 31a of the fail valve 31 is in a compressed state, which corresponds to the normal state that the fluid passage 33 and the impeller clutch fluid passage 24 are connected by the fail valve 31. Accordingly, the electronic control portion 36 enables to control the engagement or disengagement of the impeller clutch 13a by controlling the on-off solenoid valve 35 (i.e., by controlling the impeller clutch control valve 34), and a vehicle is operable by the control of the on-off solenoid valve 35 to engage the impeller clutch 13a to establish the engaging state.

Third, in a case where the fail valve 31 fails in a state the spring 31a is compressed, similar to the second case, the fluid passage 33 and the impeller clutch fluid passage 24 are connected by the fail valve 31, which corresponds to the normal state. Accordingly, the electronic control portion 36 enables to control the engagement or disengagement of the impeller clutch 13a by controlling the on-off solenoid valve 35 (i.e., by controlling the impeller clutch control valve 34), and a vehicle is operable by the control of the on-off solenoid valve 35 to engage the impeller clutch 13a to establish the engaging state.

Fourth, in a case where the fail valve 31 fails in a state where the spring 31a is expanded, similar to the first case, because the supply source of the secondary pressure and the impeller clutch fluid passage 24 are connected by the fail valve 31, a control by the electronic control portion 36 cannot be performed, in other words, the electronic control portion 36 is not operational. However, because the secondary pressure (Sec pressure) is supplied to the impeller clutch hydraulic pressure chamber R3 via the fail valve 31 and the impeller clutch fluid passage 24 to engage the impeller clutch 13a to establish the engaging state, a vehicle is operable.

Fifth, in a case where the on-off solenoid valve 35 fails in a state where the hydraulic pressure is generated (energized state), because the impeller clutch control valve 34 continues to output the secondary pressure (Sec pressure), irrespective of the operation of the line pressure linear solenoid valve 37 by the electronic control portion 36, the secondary pressure (Sec pressure) is provided to the impeller clutch fluid passage 24 via the fail valve 31. Thus, because the secondary pressure (Sec pressure) is supplied to the impeller clutch hydraulic pressure chamber R3 via the impeller clutch fluid passage 24 to engage the impeller clutch 13a to establish the engaging state, the vehicle is operable.

Sixth, in a case where the on-off solenoid valve 35 fails in a state where the on-off solenoid valve 35 does not generate the hydraulic pressure (non-energized state), the secondary pressure (Sec pressure) is not outputted via the impeller clutch control valve 34. When detecting the foregoing state, the electronic control portion 36 controls the line pressure linear solenoid valve 37 connected to the fail valve 31 to be in a non-energized state. Accordingly, because the secondary pressure (Sec pressure) is supplied to the impeller clutch hydraulic pressure chamber R3 via the fail valve 31 and the impeller clutch fluid passage 24 to engage the impeller clutch 13a to establish the engaging state, the vehicle is operable.

Seventh, in a case where the impeller clutch control valve 34 fails in a state where the spring 34a is compressed, similar to the fifth case, because the impeller clutch control valve 34 continues to output the secondary pressure (Sec pressure), irrespective of the operation of the line pressure linear solenoid valve 37 by the electronic control portion 36, the secondary pressure (Sec pressure) is provided to the impeller clutch fluid passage 24 via the fail valve 31. Thus, because the secondary pressure (Sec pressure) is supplied to the impeller clutch hydraulic pressure chamber R3 to engage the impeller clutch 13a to establish the engaging state, the vehicle is operable.

Eighth, in a case where the impeller clutch control valve 34 fails in a state where the spring 34a is expanded, similar to the sixth case, the secondary pressure (Sec pressure) is not outputted via the impeller clutch control valve 34. When detecting the foregoing state, the electronic control portion 36 controls the line pressure linear solenoid valve 37 connected to the fail valve 31 to be in a non-energized state. Accordingly, because the secondary pressure (Sec pressure) is supplied to the impeller clutch hydraulic pressure chamber R3 via the fail valve 31 and the impeller clutch fluid passage 24 to engage the impeller clutch 13a to establish the engaging state, the vehicle is operable.

Ninth, in a case of a failure at which all electronic parts are in a non-energized state, the line pressure linear solenoid valve 37 connected to the fail valve 31 assumes a non-energized state to output the maximum level pressure, and the secondary pressure (Sec pressure) is supplied to the impeller clutch hydraulic pressure chamber R3 via the fail valve 31 and the impeller clutch fluid passage 24 to engage the impeller clutch 13a to establish the engaging state. Accordingly, the vehicle is operable.

According to the constructions of the second embodiment, similar to the first embodiment, because the impeller clutch 13a is securely engaged even if any components of the hydraulic pressure control apparatus fail, the vehicle is prevented from being inoperable, thus the safety of the vehicle is enhanced.

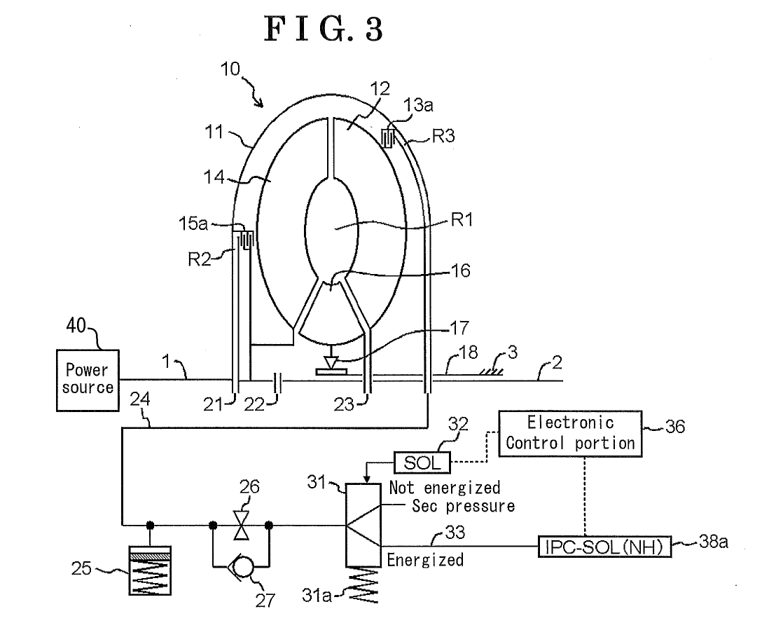

A third embodiment of the hydraulic pressure control apparatus for the hydraulic power transmission will be explained with reference to FIG. 3. A hydraulic pressure circuit with respect only to the impeller clutch is shown in FIG. 3.

A third embodiment is a modified example of the hydraulic pressure circuit of the first embodiment, which includes the multi-plate impeller clutch 13a. According to the construction of the first embodiment, the on-off solenoid valve (35 in FIG. 1) is connected to the control hydraulic chamber of the impeller clutch control valve (34 in FIG. 1) and the fluid paths connected to the fluid passage (33 in FIG. 1) are switched by controlling the hydraulic pressure of the on-off solenoid valve (35 in FIG. 1). On the other hand, according to constructions of the third embodiment, the hydraulic pressure supplied to the fluid passage 33 is controlled by controlling the hydraulic pressure of an impeller clutch linear solenoid valve 38a. Other constructions of the third embodiment are similar to the first embodiment. Here, the secondary pressure (Sec pressure) is defined by reducing the hydraulic pressure (line pressure) outputted from the oil pump.

The impeller clutch linear solenoid valve 38a is configured to adjust the secondary pressure (Sec pressure) in accordance with a level of an electric current and output the adjusted secondary pressure. The impeller clutch linear solenoid valve 38a is a normally high solenoid valve which either outputs the hydraulic pressure corresponding to the reduced secondary pressure (Sec pressure) or does not output the hydraulic pressure when energized, and which outputs the secondary pressure (Sec pressure) when not energized. The impeller clutch linear solenoid valve 38a is controlled by the electronic control portion 36.

A normal operation of the electronic control portion of the hydraulic pressure control apparatus for the hydraulic power transmission according to the third embodiment will be explained as follows.

In a case where the engine is idling, the electronic control portion 36 connects the impeller clutch fluid passage 24 and the fluid passage 33 by controlling the on-off solenoid valve 32 to supply the hydraulic pressure to the control hydraulic chamber of the fail valve 31 (i.e., controlling the on-off solenoid valve 32 to be energized), and by controlling the impeller clutch linear solenoid valve 38a not to supply the hydraulic pressure (i.e., controlling the impeller clutch linear solenoid valve 38a to be energized) the hydraulic pressure is controlled not to be supplied to the impeller clutch hydraulic pressure chamber R3, and thus the impeller clutch 13a is disengaged.

On the other hand, when the engine is not idling, the electronic control portion 36 controls the on-off solenoid valve 32 to supply the hydraulic pressure to the control hydraulic chamber of the fail valve 31 by adjusting the pressure level (i.e., controls the on-off solenoid valve 32 to be energized) to connect the impeller clutch fluid passage 24 and the fluid passage 33, and controls the impeller clutch linear solenoid valve 38a to supply the secondary pressure (Sec pressure) to the impeller clutch hydraulic pressure chamber R3 (i.e., controls the impeller clutch linear solenoid valve 38a to be in a non-energized state) via the impeller clutch control valve 34, the fluid passage 33, the fail valve 31, and the impeller clutch fluid passage 24 to engage the impeller clutch 13a to establish the engaging state.

A control operation of the electronic control portion when a component of the hydraulic pressure control apparatus for the hydraulic power transmission according to the third embodiment fails will be explained hereinafter.

First, in a case where the on-off solenoid valve 32 fails in a state where the on-off solenoid valve 32 is controlled so as to output the hydraulic pressure (energized state), the spring 31a of the fail valve 31 is in a compressed state, which corresponds to the normal state that the fluid passage 33 and the impeller clutch fluid passage 24 are connected by the fail valve 31. Accordingly, the electronic control portion 36 enables to control the engagement or disengagement of the impeller clutch 13a by controlling the impeller clutch linear solenoid valve 38a, and a vehicle is operable by the control of the clutch linear solenoid valve 38a to engage the impeller clutch 13a to establish the engaging state.

Second, in a case where the on-off solenoid valve 32 fails in a state where the hydraulic pressure is not outputted (non-energized state), the spring 31a of the fail valve 31 is in an expanded state, and the fail valve 31 connects the supply source of the secondary pressure (Sec pressure) and the impeller clutch fluid passage 24. Accordingly, a control by the electronic control portion 36 cannot be performed. In other words, the electronic control portion 36 is not operable. However, because the secondary pressure (Sec pressure) is supplied to the impeller clutch hydraulic pressure chamber R3 via the fail valve 31 and the impeller clutch fluid passage 24 to engage the impeller clutch 13a to establish the engaging state, a vehicle is operable.

Third, in a case where the fail valve 31 fails in a state where the spring 31a is compressed, similar to the first case, because the normal state where the fluid passage 33 and the impeller clutch fluid passage 24 are connected by the fail valve 31 is attained, the electronic control portion 36 enables to control the engagement and disengagement of the impeller clutch 13a by controlling the impeller clutch linear solenoid valve 38a, and a vehicle is operable by the control of the clutch linear solenoid valve 38a to engage the impeller clutch 13a to establish the engaging state.

Fourth, in a case where the fail valve 31 fails in a state where the spring 31a is expanded, similar to the second case, because the fail valve 31 connects the secondary pressure (Sec pressure) and the impeller clutch fluid passage 24, a control by the electronic control portion 36 cannot be performed. In other words, the electronic control portion 36 is not operational. However, a vehicle is operable because the secondary pressure (Sec pressure) is supplied to the impeller clutch hydraulic pressure chamber R3 via the fail valve 31 and the impeller clutch fluid passage 24 to engage the impeller clutch 13a to establish the engaging state.

Fifth, in a case where the impeller clutch linear solenoid valve 38a fails in a state where the hydraulic pressure is generated (non-energized state), because the impeller clutch linear solenoid valve 38a continues to output the secondary pressure (Sec pressure), irrespective of the operation of the on-off solenoid valve 32 by the electronic control portion 36, the secondary pressure (Sec pressure) is provided to the impeller clutch fluid passage 24 via the fail valve 31. Thus, because the secondary pressure (Sec pressure) is supplied to the impeller clutch hydraulic pressure chamber R3 to engage the impeller clutch 13a to establish the engaging state, the vehicle is operable.

Sixth, a case where the impeller clutch linear solenoid valve 38a fails in a state where the impeller clutch linear solenoid valve 38a does not generate the hydraulic pressure (energized state) will be explained as follows. When detecting the state that the impeller clutch linear solenoid valve 38a dose not output the hydraulic pressure, the electronic control portion 36 controls the on-off solenoid valve 32 connected to the fail valve 31 to be in a non-energized state. Accordingly, because the secondary pressure (Sec pressure) is supplied to the impeller clutch hydraulic pressure chamber R3 via the fail valve 31 and the impeller clutch fluid passage 24 to engage the impeller clutch 13a to establish the engaging state, the vehicle is operable.

Seventh, in a case of a failure at which all electronic parts are in a non-energized state, the on-off solenoid valve 32 connected to the fail valve 31 becomes a non-energized state so as not to output the hydraulic pressure, and the secondary pressure (Sec pressure) is supplied to the impeller clutch hydraulic pressure chamber R3 via the fail valve 31 and the impeller clutch fluid passage 24 to engage the impeller clutch 13a to establish the engaging state. Accordingly, the vehicle is operable.

According to the construction of the third embodiment, because the impeller clutch 13a is securely engaged even if any components of the hydraulic pressure control apparatus fail, the vehicle is prevented from being inoperable, thus the safety of the vehicle is enhanced.

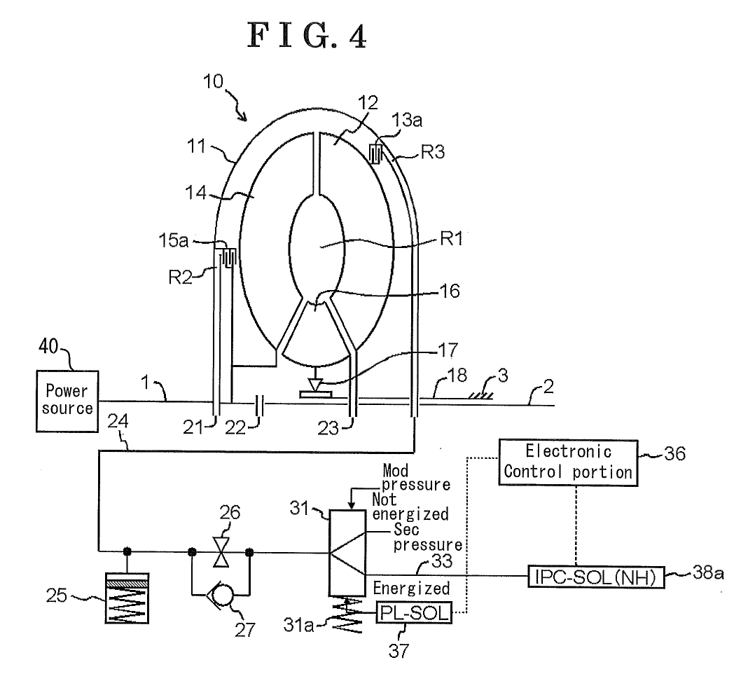

A hydraulic pressure control apparatus for the hydraulic power transmission according to a fourth embodiment will be explained with reference to FIG. 4. A hydraulic pressure circuit with respect to the impeller clutch is illustrated in FIG. 4

The fourth embodiment is a modified example of the hydraulic pressure circuit of the first embodiment, which includes the multi-plate impeller clutch 13a. According to the construction of the first embodiment, the on-off solenoid valve (35 in FIG. 1) is connected to the control hydraulic chamber of the impeller clutch control valve (34 in FIG. 1) and the fluid paths connected to the fluid passage (33 in FIG. 1) are switched by controlling the hydraulic pressure of the on-off solenoid valve (35 in FIG. 1), and the on-off solenoid valve (32 in FIG. 1) is connected to the control hydraulic chamber of the fail valve (31 in FIG. 1) to switch the fluid paths of the fail valve (31 in FIG. 1) by controlling the hydraulic pressure of the on-off solenoid valve (32 in FIG. 1). On the other hand, according to constructions of the fourth embodiment, a level of the hydraulic pressure to be supplied to the fluid passage 33 can be controlled by controlling the hydraulic pressure of the impeller clutch linear solenoid valve 38a and a supply source of a modulator pressure (Mod pressure) having a constant hydraulic pressure is connected to the control hydraulic chamber of the fail valve 31, the line pressure linear solenoid valve 37 is connected to the spring chamber which houses the spring 31a of the fail valve 31, and the fluid paths of the fail valve 31 are switched by controlling the hydraulic pressure of the line pressure linear solenoid valve 37. Other constructions of the fourth embodiment are similar to the first embodiment. Further, the constructions of the fail valve 31 and the line pressure linear solenoid valve 37 of the fourth embodiment are similar to the fail valve (31 in FIG. 2) and the line pressure linear solenoid valve (37 in FIG. 2) of the second embodiment. The construction of the impeller clutch linear solenoid valve 38a of the fourth embodiment is similar to the impeller clutch linear solenoid valve (38a in FIG. 3) of the third embodiment. In those circumstances, the modulator pressure (Mod pressure) corresponds to the adjusted hydraulic pressure defined by reducing the hydraulic pressure (line pressure) outputted from the oil pump.

A normal operation of the electronic control portion of the hydraulic pressure control apparatus for the hydraulic power transmission of the fourth embodiment will be explained as follows.

In a case where the engine is idling, the electronic control portion 36 connects the impeller clutch fluid passage 24 and the fluid passage 33 by controlling the line pressure linear solenoid valve 37 not to supply the hydraulic pressure to the spring chamber of the fail valve 31 (i.e., controlling the line pressure linear solenoid valve 37 to be energized), and the electronic control portion 36 controls the impeller clutch linear solenoid valve 38a not to supply the hydraulic pressure to the impeller clutch hydraulic pressure chamber R3 (i.e., controlling the impeller clutch linear solenoid valve 38a to be energized), thus to disengage the impeller clutch 13a to establish the disengaging state.

On the other hand, when the engine is not idling, the electronic control portion 36 controls the line pressure linear solenoid valve 37 not to supply the hydraulic pressure to the spring chamber of the fail valve 31 (i.e., controls the line pressure linear solenoid valve 37 to be energized) to connect the impeller clutch fluid passage 24 and the fluid passage 33, and controls the impeller clutch linear solenoid valve 38a to supply the secondary pressure (Sec pressure) to the impeller clutch hydraulic pressure chamber R3 (i.e., controls the impeller clutch linear solenoid valve 38a to be in a non-energized state) via the impeller clutch control valve 34, the fluid passage 33, the fail valve 31, and the impeller clutch fluid passage 24 to engage the impeller clutch 13a to establish the engagement state.

A control operation of the electronic control portion when a component of the hydraulic pressure control apparatus for the hydraulic power transmission according to the fourth embodiment fails will be explained hereinafter.

First, in a case where the line pressure linear solenoid valve 37 fails in a state where the hydraulic pressure is outputted (non-energized state), the spring 31a of the fail valve 31 is in an expanded state, and the fail valve 31 connects the supply source of the secondary pressure (Sec pressure) and the impeller clutch fluid passage 24. Accordingly, a control by the electronic control portion 36 cannot be performed. In other words, the electronic control portion 36 is not operational. However, because the secondary pressure (Sec pressure) is supplied to the impeller clutch hydraulic pressure chamber R3 via the fail valve 31 and the impeller clutch fluid passage 24 to engage the impeller clutch 13a to establish the engaging state, a vehicle is operable.

Second, in a case where the line pressure linear solenoid valve 37 fails in a state where the line pressure linear solenoid valve 37 does not output the hydraulic pressure (energized state), the spring 31a of the fail valve 31 is in a compressed state, which corresponds to the normal state that the fluid passage 33 and the impeller clutch fluid passage 24 are connected by the fail valve 31. Accordingly, the electronic control portion 36 enables to control the engagement or disengagement of the impeller clutch 13a by controlling the impeller clutch linear solenoid valve 38a, and a vehicle is operable by the control of the clutch linear solenoid valve 38a to engage the impeller clutch 13a to establish the engaging state.

Third, in a case where the fail valve 31 fails in a state where the spring 31a is compressed, similar to the second case, the fluid passage 33 and the impeller clutch fluid passage 24 are connected by the fail valve 31, which corresponds to the normal state. Accordingly, the electronic control portion 36 enables to control the engagement or disengagement of the impeller clutch 13a by controlling the impeller clutch linear solenoid valve 38a, and a vehicle is operable by the control of the clutch linear solenoid valve 38a to engage the impeller clutch 13a to establish the engaging state.

Fourth, in a case where the fail valve 31 fails in a state where the spring 31a is expanded, similar to the first case, because the supply source of the secondary pressure and the impeller clutch fluid passage 24 are connected by the fail valve 31, a control by the electronic control portion 36 cannot be performed. That is, the electronic control portion 36 is not operational. However, because the secondary pressure (Sec pressure) is supplied to the impeller clutch hydraulic pressure chamber R3 via the fail valve 31 and the impeller clutch fluid passage 24 to engage the impeller clutch 13a to establish the engaging state, a vehicle is operable.

Fifth, in a case where the impeller clutch linear solenoid valve 38a fails in a state where the hydraulic pressure is generated (non-energized state), because the impeller clutch linear solenoid valve 38a continues to output the secondary pressure (Sec pressure), irrespective of the operation of the line pressure linear solenoid valve 37 by the electronic control portion 36, the secondary pressure (Sec pressure) is provided to the impeller clutch fluid passage 24 via the fail valve 31. Thus, because the secondary pressure (Sec pressure) is supplied to the impeller clutch hydraulic pressure chamber R3 to engage the impeller clutch 13a to establish the engagement state, the vehicle is operable.

Sixth, in a case where the impeller clutch linear solenoid valve 38a fails in a state where the impeller clutch linear solenoid valve 38a does not generate the hydraulic pressure (energized state), when detecting that the impeller clutch linear solenoid valve 38a does not output the hydraulic pressure, the electronic control portion 36 controls the line pressure linear solenoid valve 37 connected to the fail valve 31 to be in a non-energized state. Accordingly, because the secondary pressure (Sec pressure) is supplied to the impeller clutch hydraulic pressure chamber R3 via the fail valve 31 and the impeller clutch fluid passage 24 to engage the impeller clutch 13a to establish the engagement state, the vehicle is operable.

Seventh, in a case of a failure at which all electronic parts are in the non-energized state, the line pressure linear solenoid valve 37 connected to the fail valve 31 assumes a non-energized state to output the maximum level pressure, and the secondary pressure (Sec pressure) is supplied to the impeller clutch hydraulic pressure chamber R3 via the fail valve 31 and the impeller clutch fluid passage 24 to engage the impeller clutch 13a to establish the engaging state. Accordingly, the vehicle is operable.

According to the constructions of the fourth embodiment, likewise the first embodiment, because the impeller clutch 13a is securely engaged even if any components of the hydraulic pressure control apparatus fail, the vehicle is prevented from being inoperable, thus the safety of the vehicle is enhanced.

A hydraulic pressure control apparatus for the hydraulic power transmission according to a fifth embodiment will be explained with reference to FIG. 5. A hydraulic pressure circuit with respect to only the impeller clutch is shown in FIG. 5 for an explanatory purpose.

The hydraulic pressure control apparatuses for the hydraulic power transmission including the multi-plate impeller clutch (13a in FIGS. 1 to 4) are explained in the first to fourth embodiments. On the other hand, a hydraulic pressure control apparatus for the hydraulic power transmission having a single plate impeller clutch 13b is disclosed in the fifth embodiment. FIG. 5 discloses the hydraulic pressure control apparatus for the torque converter 10 including the single-plate impeller clutch 13b which is configured to disengage the pump impeller 12 from the converter shell 11 which rotates integrally with the power source (e.g., engine) 40. The hydraulic pressure control apparatus controls the hydraulic pressure to be supplied to the impeller clutch 13b, and engages the impeller clutch 13b by not supplying the hydraulic pressure and disengages the impeller clutch 13b by supplying the hydraulic pressure thereto. The hydraulic pressure control apparatus includes, with respect to the single-plate impeller clutch 13b, the impeller clutch fluid passage 24, the fail valve 31, the on-off solenoid valve 32, the fluid passage 33, the impeller clutch control valve 34, the on-off solenoid valve 35, the electronic control portion 36, the hydraulic power transmission chamber R1, the lock-up clutch hydraulic pressure chamber R2, and the impeller clutch hydraulic pressure chamber R3.

The torque converter 10 disclosed in FIG. 5 includes the single-plate impeller clutch 13b in place of the multi-plate impeller clutch (13a in FIGS. 1 to 4) of the torque converter (10 in FIGS. 1 to 4) of the first to fourth embodiments. Other constructions of the fifth embodiment are similar to the torque converter (10 in FIGS. 1 to 4) of the first to fourth embodiments.

The impeller clutch 13b is a single-plate type clutch mechanism which is configured to transmit a rotational force (torque) of the converter shell 11 to the pump impeller 12 by establishing the engaging state. The impeller clutch 13b includes a single type clutch plate which is fixed to a member integrally rotating with the pump impeller 12. The impeller clutch 13b establishes the engaging state when the hydraulic pressure in the hydraulic power transmission chamber R1 is greater than the hydraulic pressure of the impeller clutch hydraulic pressure chamber R3 by pressing the clutch plate to frictionally engage with an inner wall surface of the converter shell 11. Further, the impeller clutch 13b establishes a disengaging state when the hydraulic pressure in the impeller clutch hydraulic pressure chamber R3 is greater than the hydraulic pressure in the hydraulic power transmission chamber R1 by separating the clutch plate from the converter shell 11 to be relatively rotatable.

The impeller clutch hydraulic pressure chamber R3 is the hydraulic pressure chamber for operating the single-plate impeller clutch 13b. The impeller clutch hydraulic pressure chamber R3 is connected to the impeller clutch fluid passage 24. When a hydraulic pressure lower than the hydraulic pressure in the hydraulic power transmission chamber R1 is supplied to the impeller clutch hydraulic pressure chamber R3, the impeller clutch 13b engages, and the impeller clutch 13b disengages (is released) when the hydraulic pressure in the impeller clutch hydraulic pressure chamber R3 becomes greater than the hydraulic pressure in the hydraulic power transmission chamber R1.

The impeller clutch fluid passage 24 connects the impeller clutch hydraulic pressure chamber R3 and the fail valve 31.

The fail valve 31 is configured to selectively connect the impeller clutch fluid passage 24 to a discharge fluid passage DL or the impeller clutch control valve 34. The fail valve 31 includes a valve body, a spool slidably provided in the valve body, and a spring 31a biasing the spool towards a control hydraulic chamber. The control hydraulic chamber is connected to the on-off solenoid valve 32. The fail valve 31 connects the impeller clutch fluid passage 24 and the impeller clutch control valve 34 so that the pressure is adjustable when a hydraulic pressure greater than a biasing force of the spring 31a is supplied from the on-off solenoid valve 32 to the control hydraulic chamber (i.e., when the on-off solenoid valve 32 is energized and the spring 31a is compressed). The fail valve 31 connects the impeller clutch fluid passage 24 and the discharge fluid passage DL when a hydraulic pressure is not supplied from the on-off solenoid valve 32 to the control hydraulic chamber (i.e., when the on-off solenoid valve 32 is not energized and the spring 31a is expanded). Here, the secondary pressure (Sec pressure) corresponds to a hydraulic pressure which is adjusted by reducing the hydraulic pressure outputted from an oil pump (i.e., line pressure). Further, the discharge fluid passage DL is configured to discharge the hydraulic pressure.

The on-off solenoid valve 32 controls whether or not to supply the hydraulic pressure to the control hydraulic chamber of the fail valve 31. The on-off solenoid valve 32 is a normally low solenoid valve which outputs the hydraulic pressure when energized and which does not output the hydraulic pressure when not energized. The on-off solenoid valve 32 is controlled by the electronic control portion 36. In place of the on-off solenoid valve 32, a linear solenoid valve which adjust a hydraulic pressure in accordance with a level of an electric current may be applied.

The fluid passage 33 connects the impeller clutch control valve 34 and the fail valve 31.

The impeller clutch control valve 34 is configured to connect the fluid passage 33 and the supply source of the secondary pressure (Sec pressure) or a discharge circuit DL. The impeller clutch control valve 34 includes the valve body, a spool slidably provided in the valve body, and the spring 34a biasing the spool towards the control hydraulic chamber. The control hydraulic chamber is connected to the on-off solenoid valve 35. The impeller clutch control valve 34 connects the fluid passage 33 and the discharge circuit DL when a hydraulic pressure greater than a biasing force of the spring 34a is supplied from the on-off solenoid valve 35 to the control hydraulic chamber (i.e., when the on-off solenoid valve 35 is energized and the spring 34a is compressed). The impeller clutch control valve 34 connects the fluid passage 33 and the source of the secondary pressure (Sec pressure) when a hydraulic pressure is not supplied from the on-off solenoid valve 35 to the control hydraulic chamber (i.e., when the on-off solenoid valve 35 is not energized and the spring 34a is expanded).

The on-off solenoid valve 35 controls whether or not to supply the hydraulic pressure to the control hydraulic chamber of the impeller clutch control valve 34. The on-off solenoid valve 35 is a normally low solenoid valve which outputs the hydraulic pressure when energized and which does not output the hydraulic pressure when not energized. The on-off solenoid valve 35 is controlled by the electronic control portion 36. According to the embodiment, the normally low solenoid valve is applied as the on-off solenoid valve 35, however, a normally high solenoid valve may also be applied.

The electronic control portion 36 is a computer which controls operations of the on-off solenoid valve 32 and the on-off solenoid valve 35. The electronic control portion 36 performs information processing based on a predetermined program (i.e., including a data base, a map, or the like). The electronic control portion 36 performs information processing in accordance with signals sent from various sensors of a vehicle. The electronic control portion 36 judges whether the engine is idling or not, and controls the impeller clutch 13b to be disengaged in order to reduce the fluid resistance between the turbine runner 14 and the pump impeller 12 when the engine is idling. A control operation of the electronic control portion 36 will be explained in more details hereinafter.

A normal control operation of the electronic control portion of the hydraulic pressure control apparatus for the hydraulic power transmission according to the fifth embodiment will be explained as follows.

In a case where the engine is idling, the electronic control portion 36 connects the impeller clutch fluid passage 24 and the fluid passage 33 by controlling the on-off solenoid valve 32 to supply the hydraulic pressure to the control hydraulic chamber of the fail valve 31 (i.e., controlling the on-off solenoid valve 32 to be energized), and by controlling the on-off solenoid valve 35 not to supply the hydraulic pressure to the control hydraulic chamber of the impeller clutch control valve 34 (i.e., controlling the on-off solenoid valve 35 not to be energized) the electronic control portion 36 connects the fluid passage 33 and the source of the secondary pressure (Sec pressure) so that the secondary pressure is supplied to the impeller clutch hydraulic pressure chamber R3 via the impeller clutch control valve 34, the fluid passage 33, the fail valve 31, and the impeller clutch fluid passage 24, to disengage the impeller clutch 13b to establish the disengaging state.

On the other hand, when the engine is not idling, the electronic control portion 36 controls the on-off solenoid valve 32 to supply the hydraulic pressure to the control hydraulic chamber of the fail valve 31 (i.e., controls the on-off solenoid valve 32 to be energized) to connect the impeller clutch fluid passage 24 and the fluid passage 33, and controls the on-off solenoid valve 35 to supply the hydraulic pressure to the control hydraulic chamber of the impeller clutch control valve 34 (i.e., controls the on-off solenoid valve 35 to be energized) to connect the fluid passage 33 and the discharge circuit DL so that the hydraulic pressure in the impeller clutch hydraulic pressure chamber R3 is discharged from the discharge circuit DL via the impeller clutch fluid passage 24, the fail valve 31, the fluid passage 33, and the impeller clutch control valve 34 to engage the impeller clutch 13b to establish the engaging state.

A control operation of the electronic control portion when a component of the hydraulic pressure control apparatus for the hydraulic power transmission according to the fifth embodiment fails will be explained hereinafter.

First, in a case where the on-off solenoid valve 32 fails in a state where the on-off solenoid valve 32 is controlled to output the hydraulic pressure (energized state), the spring 31a of the fail valve 31 is in a compressed state, which corresponds to the normal state that the fluid passage 33 and the impeller clutch fluid passage 24 are connected by the fail valve 31. Accordingly, the electronic control portion 36 enables to control the engagement or disengagement of the impeller clutch 13b by controlling the on-off solenoid valve 35 (i.e., by controlling the impeller clutch control valve 34), and a vehicle is operable by the control of the impeller clutch 13b to establish the engaging state.

Second, in a case where the on-off solenoid valve 32 fails in a state where the hydraulic pressure is not outputted (non-energized state), the spring 31a of the fail valve 31 is in an expanded state, and the fail valve 31 connects the discharge circuit DL and the impeller clutch fluid passage 24. Accordingly, a control by the electronic control portion 36 cannot be performed. In other words, the electronic control portion 36 is not operational. However, because the hydraulic pressure in the impeller clutch hydraulic pressure chamber R3 is discharged to the discharge circuit DL via the impeller clutch fluid passage 24 and the fail valve 31 to engage the impeller clutch 13b to establish the engaging state, a vehicle is operable.

Third, in a case where the fail valve 31 fails in a state where the spring 31a is compressed, similar to the first case, because the normal state where the fluid passage 33 and the impeller clutch fluid passage 24 are connected by the fail valve 31 is attained, the electronic control portion 36 enables to control the engagement and disengagement of the impeller clutch 13b by controlling the on-off solenoid valve 35 (i.e., controlling the impeller clutch control valve 34), and a vehicle is operable by the control of the impeller clutch 13b to establish the engaging state.

Fourth, in a case where the fail valve 31 fails in a state where the spring 31a is expanded, similar to the second case, because the fail valve 31 connects the discharge circuit DL and the impeller clutch fluid passage 24, a control by the electronic control portion 36 cannot be performed. That is, the electronic control portion 36 is not operational. However, a vehicle is operable because the hydraulic pressure in the impeller clutch hydraulic pressure chamber R3 is discharged to the discharge circuit DL via the impeller clutch fluid passage 24 and the fail valve 31 to engage the impeller clutch 13b.

Fifth, in a case where the on-off solenoid valve 35 fails in a state where the hydraulic pressure is generated (energized state), because the impeller clutch control valve 34 remains to connect the fluid passage 33 and the discharge circuit DL, irrespective of the operation of the on-off solenoid valve 32 by the electronic control portion 36, the fail valve 31 connects the impeller clutch fluid passage 24 and the discharge circuit DL. Thus, the hydraulic pressure in the impeller clutch hydraulic pressure chamber R3 is discharged to the discharge circuit DL via the impeller clutch fluid passage 24 and the fail valve 31 to engage the impeller clutch 13b to establish the engaging state, and the vehicle is operable, accordingly.

Sixth, in a case where the on-off solenoid valve 35 fails in a state where the on-off solenoid valve 35 does not generate the hydraulic pressure (non-energized state), the impeller clutch control valve 34 outputs the secondary pressure (Sec pressure). When detecting the foregoing state, the electronic control portion 36 controls the on-off solenoid valve 32 connected to the fail valve 31 to be in a non-energized state. Accordingly, because the fail valve 31 connects the impeller clutch fluid passage 24 and the discharge circuit DL, and the hydraulic pressure in the impeller clutch hydraulic pressure chamber R3 is discharged to the discharge circuit DL via the impeller clutch fluid passage 24 and the fail valve 31 to engage the impeller clutch 13b to establish the engaging state, the vehicle is operable.

Seventh, in a case where the impeller clutch control valve 34 fails in a state where the spring 34a is compressed, similar to the fifth case, because the impeller clutch control valve 34 remains to connect the fluid passage 33 and the discharge circuit DL, irrespective of the operation of the on-off solenoid valve 32 by the electronic control portion 36, the fail valve 31 connects the impeller clutch fluid passage 24 and the discharge circuit DL. Thus, the hydraulic pressure in the impeller clutch hydraulic pressure chamber R3 is discharged to the discharge circuit DL via the impeller clutch fluid passage 24 and the fail valve 31 to engage the impeller clutch 13b to establish the engaging state, and the vehicle is operable, accordingly.

Eighth, in a case where the impeller clutch control valve 34 fails in a state where the spring 34a is expanded, similar to the sixth case, the impeller clutch control valve 34 outputs the secondary pressure (Sec pressure). When detecting the foregoing state, the electronic control portion 36 controls the on-off solenoid valve 32 connected to the fail valve 31 to be in a non-energized state. Accordingly, because the fail valve 31 connects the impeller clutch fluid passage 24 and the discharge circuit DL, and the hydraulic pressure in the impeller clutch hydraulic pressure chamber R3 is discharged to the discharge circuit DL via the impeller clutch fluid passage 24 and the fail valve 31 to engage the impeller clutch 13b to establish the engaging state, the vehicle is operable.

Ninth, in a case of a failure at which all electronic parts are in a non-energized state, the on-off solenoid valve 32 connected to the fail valve 31 becomes a non-energized state so as not to output the hydraulic pressure, and the fail valve 31 connects the impeller clutch fluid passage 24 and the discharge circuit DL to discharge the hydraulic pressure in the impeller clutch hydraulic pressure chamber R3 to the discharge circuit DL via the impeller clutch fluid passage 24 and the fail valve 31 to engage the impeller clutch 13b to establish the engaging state. Accordingly, the vehicle is operable.

According to the construction of the fifth embodiment, because the impeller clutch 13b is securely engaged even if any components of the hydraulic pressure control apparatus fail, the vehicle is prevented from being inoperable, thus the safety of the vehicle is enhanced.

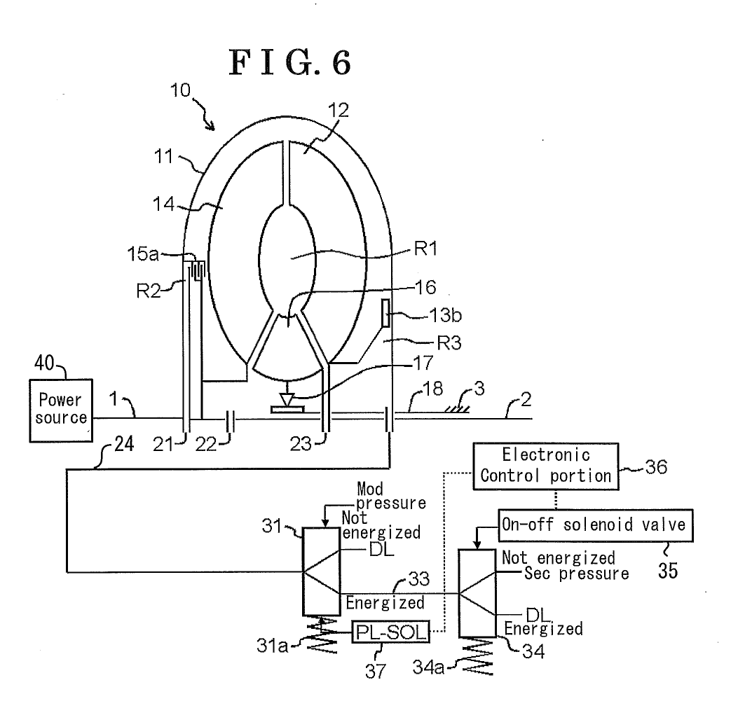

A hydraulic pressure control apparatus for a hydraulic power transmission according to a sixth embodiment will be explained with reference to FIG. 6. A hydraulic pressure circuit only with respect to the impeller clutch is shown in FIG. 6.

The sixth embodiment discloses a modified example of the hydraulic pressure circuit of the fifth embodiment, which includes the single impeller clutch 13b. According to the construction of the fifth embodiment, the on-off solenoid valve (see 32 in FIG. 5) is connected to the control hydraulic chamber of the fail valve (see 31 in FIG. 5) to switch the fluid paths of the fail valve (31 in FIG. 5) by controlling the hydraulic pressure of the on-off solenoid valve (32 in FIG. 5). On the other hand, according to constructions of the sixth embodiment, a supply source of a modulator pressure (Mod pressure) which has a constant hydraulic pressure is connected to the control hydraulic chamber of the fail valve 31, a line pressure linear solenoid valve 37 is connected to a spring chamber which houses the spring 31a of the fail valve 31, and fluid paths of the fail valve 31 are switched by controlling the hydraulic pressure of the line pressure linear solenoid valve 37. Other constructions of the sixth embodiment are similar to the fifth embodiment. In those circumstances, the modulator pressure (Mod pressure) is defined by reducing a hydraulic pressure (line pressure) outputted from an oil pump.

The fail valve 31 is configured to connect the impeller clutch fluid passage 24 with the discharge circuit DL or the impeller clutch control valve 34. The fail valve 31 includes the valve body, the spool slidably provided in the valve body, and the spring 31a biasing the spool towards the control hydraulic chamber. The modulator pressure (Mod pressure) having a constant level of hydraulic pressure is introduced to the control hydraulic chamber. The line pressure linear solenoid valve 37 is connected to the spring chamber which houses the spring 31a. The fail valve 31 connects the impeller clutch fluid passage 24 and the impeller clutch control valve 34 so that the pressure is adjustable when the sum of a biasing force of the spring 31a and a hydraulic pressure of the line pressure linear solenoid valve 37 is less than the modulator pressure (Mod pressure) (i.e., when the line pressure linear solenoid valve 37 is energized and the spring 31a is compressed). The fail valve 31 connects the impeller clutch fluid passage 24 and the discharge circuit DL when the sum of the biasing force of the spring 31a and the hydraulic pressure of the line pressure linear solenoid valve 37 is greater than the modulator pressure (Mod pressure) (i.e., when the line pressure linear solenoid valve 37 is not energized and the spring 31a is expanded).

The line pressure linear solenoid valve 37 is configured to control the hydraulic pressure supplied to the spring chamber of the fail valve 31 in accordance with a level of an electric current. The line pressure linear solenoid valve 37 is a normally high solenoid valve which outputs an adjusted modulator pressure (Mod pressure) when energized (in an energized state), and which outputs the modulator pressure (Mod pressure) when not energized (in a non-energized state). The line pressure linear solenoid valve 37 is controlled by the electronic control portion 36.

A normal operation of the electronic control portion of the hydraulic pressure control apparatus for the hydraulic power transmission according to the sixth embodiment will be explained as follows.

In a case where the engine is idling, the electronic control portion 36 connects the impeller clutch fluid passage 24 and the fluid passage 33 by not supplying the hydraulic pressure from the line pressure linear solenoid valve 37 to the spring chamber of the fail valve 31 (i.e., controlling the line pressure linear solenoid valve 37 to be energized), and by controlling the on-off solenoid valve 35 not to supply the hydraulic pressure to the control hydraulic chamber of the impeller clutch control valve 34 (i.e., controlling the on-off solenoid valve 35 not to be energized) the electronic control portion 36 connects the fluid passage 33 and the source of the secondary pressure (Sec pressure) so that the secondary pressure is supplied to the impeller clutch hydraulic pressure chamber R3 via the impeller clutch control valve 34, the fluid passage 33, the fail valve 31, and the impeller clutch fluid passage 24 to disengage the impeller clutch 13b to establish the disengaging state.

On the other hand, when the engine is not idling, the electronic control portion 36 controls the line pressure linear solenoid valve 37 not to supply the hydraulic pressure to the spring chamber of the fail valve 31 (i.e., controls the line pressure linear solenoid valve 37 to be energized) to connect the impeller clutch fluid passage 24 and the fluid passage 33, and controls the on-off solenoid valve 35 to supply the hydraulic pressure to the control hydraulic chamber of the impeller clutch control valve 34 (i.e., controls the on-off solenoid valve 35 to be energized) to connect the fluid passage 33 and the discharge circuit DL so that the hydraulic pressure in the impeller clutch hydraulic pressure chamber R3 is discharged to the discharge circuit DL via the impeller clutch fluid passage 24, the fail valve 31, the fluid passage 33, and the impeller clutch control valve 34 to engage the impeller clutch 13b to establish the engaging state.

A control operation of the electronic control portion when a component of the hydraulic pressure control apparatus for the hydraulic power transmission according to the sixth embodiment fails will be explained hereinafter.

First, in a case where the line pressure linear solenoid valve 37 fails in a state where the line pressure linear solenoid valve 37 is controlled to output the hydraulic pressure (non-energized state), the spring 31a of the fail valve 31 is in an expanded state, and the fail valve 31 connects the discharge circuit DL and the impeller clutch fluid passage 24. Accordingly, a control by the electronic control portion 36 cannot be performed. That is, the electronic control portion 36 is not operational. However, because the hydraulic pressure in the impeller clutch hydraulic pressure chamber R3 is discharged to the discharge circuit DL via the impeller clutch fluid passage 24 and the fail valve 31 to engage the impeller clutch 13b to establish the engaging state, a vehicle is operable.

Second, in a case where the line pressure linear solenoid valve 37 fails in a state where the hydraulic pressure is not outputted (energized state), the spring 31a of the fail valve 31 is in a compressed state, which corresponds to the normal state that the fluid passage 33 and the impeller clutch fluid passage 24 are connected by the fail valve 31. Accordingly, the electronic control portion 36 enables to control the engagement or disengagement of the impeller clutch 13b by controlling the on-off solenoid valve 35 (i.e., by controlling the impeller clutch control valve 34), and a vehicle is operable by the control of the impeller clutch 13b to establish the engaging state.

Third, in a case where the fail valve 31 fails in a state where the spring 31a is compressed, similar to the second case, because the normal state where the fluid passage 33 and the impeller clutch fluid passage 24 are connected by the fail valve 31 is attained, the electronic control portion 36 enables to control the engagement and disengagement of the impeller clutch 13b by controlling the on-off solenoid valve 35 (i.e., controlling the impeller clutch control valve 34), and a vehicle is operable by the control of the impeller clutch 13b to establish the engaging state.

Fourth, in a case where the fail valve 31 fails in a state where the spring 31a is expanded, similar to the first case, because the fail valve 31 connects the discharge circuit DL and the impeller clutch fluid passage 24, a control by the electronic control portion 36 cannot be performed. That is, the electronic control portion 36 is not operational. However, a vehicle is operable because the hydraulic pressure in the impeller clutch hydraulic pressure chamber R3 is discharged to the discharge circuit DL via the impeller clutch fluid passage 24 and the fail valve 31 to engage the impeller clutch 13b to establish the engaging state.

Fifth, in a case where the on-off solenoid valve 35 fails in a state where the hydraulic pressure is generated (energized state), because the impeller clutch control valve 34 remains to connect the fluid passage 33 and the discharge circuit DL, irrespective of the control of the line pressure linear solenoid valve 37 by the electronic control portion 36, the fail valve 31 connects the impeller clutch fluid passage 24 and the discharge circuit DL. Thus, the hydraulic pressure in the impeller clutch hydraulic pressure chamber R3 is discharged to the discharge circuit DL via the impeller clutch fluid passage 24 and the fail valve 31 to engage the impeller clutch 13b to establish the engaging state, and the vehicle is operable, accordingly.

Sixth, in a case where the on-off solenoid valve 35 fails in a state where the on-off solenoid valve 35 does not generate the hydraulic pressure (non-energized state), the impeller clutch control valve 34 outputs the secondary pressure (Sec pressure). When detecting the foregoing state, the electronic control portion 36 controls the line pressure linear solenoid valve 37 connected to the fail valve 31 to be in a non-energized state. Accordingly, because the fail valve 31 connects the impeller clutch fluid passage 24 and the discharge circuit DL, and the hydraulic pressure in the impeller clutch hydraulic pressure chamber R3 is discharged to the discharge circuit DL via the impeller clutch fluid passage 24 and the fail valve 31 to engage the impeller clutch 13b to establish the engaging state, the vehicle is operable.

Seventh, in a case where the impeller clutch control valve 34 fails in a state where the spring 34a is compressed, similar to the fifth case, because the impeller clutch control valve 34 remains to connect the fluid passage 33 and the discharge circuit DL, irrespective of the operation of the line pressure linear solenoid valve 37 by the electronic control portion 36, the fail valve 31 connects the impeller clutch fluid passage 24 and the discharge circuit DL. Thus, the hydraulic pressure in the impeller clutch hydraulic pressure chamber R3 is discharged to the discharge circuit DL via the impeller clutch fluid passage 24 and the fail valve 31 to engage the impeller clutch 13b to establish the engaging state, and the vehicle is operable, accordingly.

Eighth, in a case where the impeller clutch control valve 34 fails in a state where the spring 34a is expanded, similar to the sixth case, the impeller clutch control valve 34 outputs the secondary pressure (Sec pressure). When detecting the foregoing state, the electronic control portion 36 controls line pressure linear solenoid valve 37 connected to the fail valve 31 to be in a non-energized state. Accordingly, because the fail valve 31 connects the impeller clutch fluid passage 24 and the discharge circuit DL, and the hydraulic pressure in the impeller clutch hydraulic pressure chamber R3 is discharged to the discharge circuit DL via the impeller clutch fluid passage 24 and the fail valve 31 to engage the impeller clutch 13b to establish the engaging state, the vehicle is operable.

Ninth, in a case of a failure at which all electronic parts are in a non-energized state, the line pressure linear solenoid valve 37 connected to the fail valve 31 becomes a non-energized state so as to output the hydraulic pressure, and the fail valve 31 connects the impeller clutch fluid passage 24 and the discharge circuit DL to discharge the hydraulic pressure in the impeller clutch hydraulic pressure chamber R3 to the discharge circuit DL via the impeller clutch fluid passage 24 and the fail valve 31 to engage the impeller clutch 13b to establish the engaging state. Accordingly, the vehicle is operable.

According to the construction of the sixth embodiment, likewise the fifth embodiment, because the impeller clutch 13b is securely engaged even if any components of the hydraulic pressure control apparatus fail, the vehicle is prevented from being inoperable, thus the safety of the vehicle is enhanced.

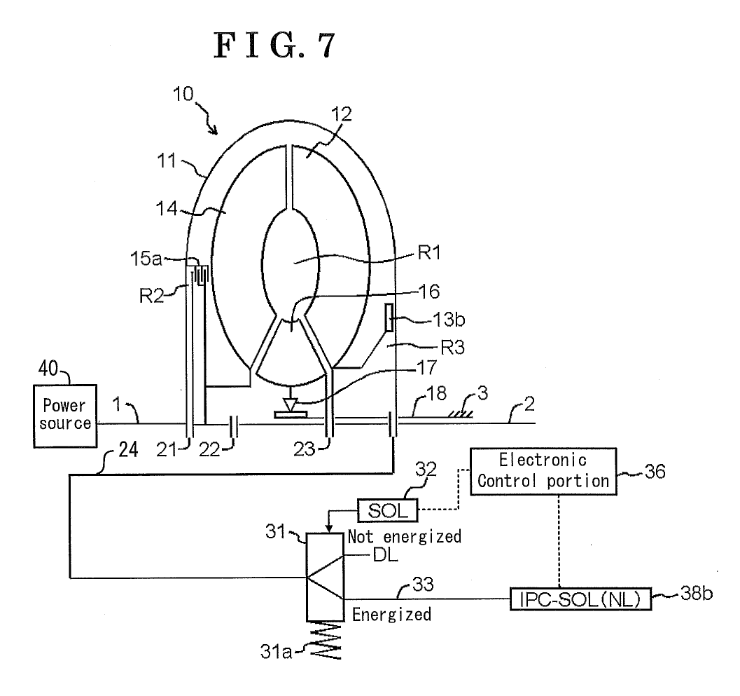

A hydraulic pressure control apparatus for a hydraulic power transmission according to a seventh embodiment will be explained with reference to FIG. 7. A hydraulic pressure circuit only with respect to the impeller clutch is shown in FIG. 7.

A seventh embodiment is a modified example of the hydraulic pressure circuit of the fifth embodiment, which includes the single-plate impeller clutch 13b. According to the construction of the fifth embodiment, the on-off solenoid valve (35 in FIG. 5) is connected to the control hydraulic chamber of the impeller clutch control valve (34 in FIG. 5) and the fluid paths connected to the fluid passage (33 in FIG. 5) are switched by controlling the hydraulic pressure of the on-off solenoid valve (35 in FIG. 5). On the other hand, according to constructions of the seventh embodiment, the hydraulic pressure supplied to the fluid passage 33 is controlled by controlling the hydraulic pressure of an impeller clutch linear solenoid valve 38b. Other constructions of the seventh embodiment are similar to the fifth embodiment. Here, the secondary pressure (Sec pressure) is defined by reducing the hydraulic pressure (line pressure) outputted from the oil pump.

The impeller clutch linear solenoid valve 38b is configured to adjust the secondary pressure (Sec pressure) in accordance with a level of an electric current and output the adjusted secondary pressure. The impeller clutch linear solenoid valve 38b is a normally low solenoid valve which outputs the secondary pressure (Sec pressure) or the adjusted secondary pressure when energized, and which does not output the hydraulic pressure when not energized. The impeller clutch linear solenoid valve 38b is controlled by the electronic control portion 36.

A normal operation of the electronic control portion of the hydraulic pressure control apparatus for the hydraulic power transmission according to the seventh embodiment will be explained as follows.

In a case where the engine is idling, the electronic control portion 36 connects the impeller clutch fluid passage 24 and the fluid passage 33 by supplying the hydraulic pressure from the on-off solenoid valve 32 to the control hydraulic chamber of the fail valve 31 (i.e., controlling the on-off solenoid valve 32 to be energized), and by controlling the impeller clutch linear solenoid valve 38b to output the hydraulic pressure (i.e., controlling the impeller clutch linear solenoid valve 38a to be energized) the secondary pressure (Sec pressure) is supplied to the impeller clutch hydraulic pressure chamber R3 via the fluid passage 33, the fail valve 31, and the impeller clutch fluid passage 24 to disengage the impeller clutch 13b to establish the disengaging state.

On the other hand, when the engine is not idling, the electronic control portion 36 controls the on-off solenoid valve 32 to supply the hydraulic pressure to the control hydraulic chamber of the fail valve 31 by adjusting the pressure level (i.e., controls the on-off solenoid valve 32 to be energized) to connect the impeller clutch fluid passage 24 and the fluid passage 33, and controls the impeller clutch linear solenoid valve 38b not to supply the secondary pressure (Sec pressure) to the impeller clutch hydraulic pressure chamber R3 (i.e., controls the impeller clutch linear solenoid valve 38b to be in a non-energized state) thus to engage the impeller clutch 13b thus to establish the engaged state.

A control operation of the electronic control portion when a component of the hydraulic pressure control apparatus for the hydraulic power transmission according to the seventh embodiment fails will be explained hereinafter.

First, in a case where the on-off solenoid valve 32 fails in a state the on-off solenoid valve 32 is controlled to output the hydraulic pressure (energized state), the spring 31a of the fail valve 31 is in a compressed state, which corresponds to the normal state that the fluid passage 33 and the impeller clutch fluid passage 24 are connected by the fail valve 31. Accordingly, the electronic control portion 36 enables to control the engagement or disengagement of the impeller clutch 13b by controlling the impeller clutch linear solenoid valve 38b, and a vehicle is operable by the control of the impeller clutch 13b to establish the engaging state.

Second, in a case where the on-off solenoid valve 32 fails in a state where the hydraulic pressure is not outputted (non-energized state), the spring 31a of the fail valve 31 is in an expanded state, and the fail valve 31 connects the discharge circuit DL and the impeller clutch fluid passage 24. Accordingly, a control by the electronic control portion 36 cannot be performed. That is, the electronic control portion 36 is not operational. However, because the hydraulic pressure in the impeller clutch hydraulic pressure chamber R3 is discharged to the discharge circuit DL via the impeller clutch fluid passage 24 and the fail valve 31 to engage the impeller clutch 13b to establish the engaging state, a vehicle is operable.

Third, in a case where the fail valve 31 fails in a state where the spring 31a is compressed, similar to the first case, because the normal state where the fluid passage 33 and the impeller clutch fluid passage 24 are connected by the fail valve 31 is attained, the electronic control portion 36 enables to control the engagement and disengagement of the impeller clutch 13b by controlling the impeller clutch linear solenoid valve 38b, and a vehicle is operable by the control of the impeller clutch linear solenoid valve 38b to engage the impeller clutch 13b to establish the engaging state.

Fourth, in a case where the fail valve 31 fails in a state where the spring 31a is expanded, similar to the second case, because the fail valve 31 connects the discharge circuit DL and the impeller clutch fluid passage 24, a control by the electronic control portion 36 cannot be performed. That is, the electronic control portion 36 is not operational. However, a vehicle is operable because the hydraulic pressure in the impeller clutch hydraulic pressure chamber R3 is discharged to the discharge circuit DL via the impeller clutch fluid passage 24 and the fail valve 31 to engage the impeller clutch 13b to establish the engaging state.

Fifth, in a case where the impeller clutch linear solenoid valve 38b fails in a state where the impeller clutch linear solenoid valve 38b is controlled to generate the hydraulic pressure (energized state), the following is performed. When detecting a state that the impeller clutch linear solenoid valve 38b outputs the hydraulic pressure, the electronic control portion 36 controls the on-off solenoid valve 32 connected to the fail valve 31 to be in a non-energized state. Accordingly, because the fail valve 31 connects the impeller clutch fluid passage 24 and the discharge circuit DL, and the hydraulic pressure in the impeller clutch hydraulic pressure chamber R3 is discharged to the discharge circuit DL via the impeller clutch fluid passage 24 and the fail valve 31 to engage the impeller clutch 13b to establish the engaging state, the vehicle is operable.

Sixth, in a case where the impeller clutch linear solenoid valve 38b fails in a state where the impeller clutch linear solenoid valve 38b does not generate the hydraulic pressure (non-energized state), irrespective of the operation of the on-off solenoid valve 32 by the electronic control portion 36, the impeller clutch fluid passage 24 is connected to the discharge circuit DL or the impeller clutch linear solenoid valve 38b which is in a state not to output the hydraulic pressure at the fail valve 31. Accordingly, the hydraulic pressure is not supplied to the impeller clutch hydraulic pressure chamber R3, the impeller clutch 13b is engaged, and the vehicle is operable.

Seventh, in a case of a failure at which all electronic parts are in a non-energized state, such as a power shut down of the electronic control portion 36, the on-off solenoid valve 32 connected to the fail valve 31 becomes a non-energized state so as not to output the hydraulic pressure, and the fail valve 31 connects the impeller clutch fluid passage 24 and the discharge circuit DL to discharge the hydraulic pressure in the impeller clutch hydraulic pressure chamber R3 to the discharge circuit DL via the impeller clutch fluid passage 24 and the fail valve 31 to engage the impeller clutch 13b to establish the engaging state. Accordingly, the vehicle is operable.

According to the construction of the seventh embodiment, likewise the fifth embodiment, because the impeller clutch 13b is securely engaged even if any components of the hydraulic pressure control apparatus fail, the vehicle is prevented from being inoperable, thus the safety of the vehicle is enhanced.

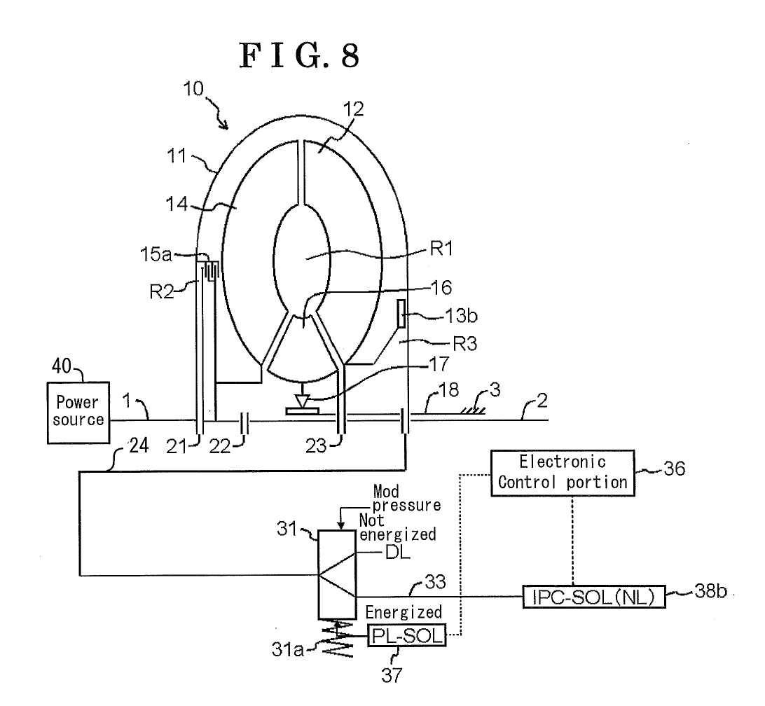

A hydraulic pressure control apparatus for a hydraulic power transmission according to an eighth embodiment will be explained with reference to FIG. 8. A hydraulic pressure circuit only with respect to the impeller clutch is shown in FIG. 8.

The eighth embodiment is a modified example of the hydraulic pressure circuit of the fifth embodiment, which includes the single-plate impeller clutch 13b. According to the construction of the fifth embodiment, the on-off solenoid valve (35 in FIG. 5) is connected to the control hydraulic chamber of the impeller clutch control valve (34 in FIG. 5) and the fluid paths connected to the fluid passage (33 in FIG. 5) are switched by controlling the hydraulic pressure of the on-off solenoid valve (35 in FIG. 5), and the on-off solenoid valve (32 in FIG. 5) is connected to the control hydraulic chamber of the fail valve (31 in FIG. 5) to switch the fluid paths of the fail valve (31 in FIG. 5) by controlling the hydraulic pressure of the on-off solenoid valve (32 in FIG. 5). On the other hand, according to constructions of the eighth embodiment, a level of the hydraulic pressure to be supplied to the fluid passage 33 can be controlled by controlling the hydraulic pressure of the impeller clutch linear solenoid valve 38b and a supply source of a modulator pressure (Mod pressure) which has a constant hydraulic pressure is connected to the control hydraulic chamber of the fail valve 31, the line pressure linear solenoid valve 37 is connected to the spring chamber which houses the spring 31a of the fail valve 31, and the fluid paths of the fail valve 31 are switched by controlling the hydraulic pressure of the line pressure linear solenoid valve 37. Other constructions of the eighth embodiment are similar to the fifth embodiment. Further, the constructions of the fail valve 31 and the line pressure linear solenoid valve 37 of the eighth embodiment are similar to the fail valve (31 in FIG. 6) and the line pressure linear solenoid valve (37 in FIG. 6) of the sixth embodiment. The construction of the impeller clutch linear solenoid valve 38b of the eighth embodiment is similar to the impeller clutch linear solenoid valve (38b in FIG. 7) of the seventh embodiment. In those circumstances, the modulator pressure (Mod pressure) corresponds to the adjusted hydraulic pressure by reducing the hydraulic pressure (line pressure) outputted from the oil pump.

A normal operation of the electronic control portion of the hydraulic pressure control apparatus for the hydraulic power transmission of the eighth embodiment will be explained as follows.

In a case where the engine is idling, the electronic control portion 36 connects the impeller clutch fluid passage 24 and the fluid passage 33 by controlling the line pressure linear solenoid valve 37 not to supply the hydraulic pressure to the spring chamber of the fail valve 31 (i.e., controlling the line pressure linear solenoid valve 37 to be energized), and by controlling the impeller clutch linear solenoid valve 38b to supply the hydraulic pressure (i.e., controlling the impeller clutch linear solenoid valve 38b to be energized), the secondary pressure (Sec pressure) is supplied to the hydraulic pressure to the impeller clutch hydraulic pressure chamber R3 via the fluid passage 33, the fail valve 31, and the impeller clutch fluid passage 24 to disengage the impeller clutch 13b to establish the engaging state.

On the other hand, when the engine is not idling, the electronic control portion 36 controls the line pressure linear solenoid valve 37 not to supply the hydraulic pressure to the spring chamber of the fail valve 31 (i.e., controls the line pressure linear solenoid valve 37 to be energized) to connect the impeller clutch fluid passage 24 and the fluid passage 33, and controls the impeller clutch linear solenoid valve 38b not to supply the hydraulic pressure (i.e., controls the impeller clutch linear solenoid valve 38b to be in a non-energized state) so that the hydraulic pressure is not supplied to the impeller clutch hydraulic pressure chamber R3 to engage the impeller clutch 13b to establish the engaging state.

A control operation of the electronic control portion when a component of the hydraulic pressure control apparatus for the hydraulic power transmission according to the eighth embodiment fails will be explained hereinafter.

First, in a case where the line pressure linear solenoid valve 37 fails in a state where the line pressure linear solenoid valve 37 is controlled to output the hydraulic pressure (non-energized state), the spring 31a of the fail valve 31 is in an expanded state, and the fail valve 31 connects the discharge circuit DL and the impeller clutch fluid passage 24. Accordingly, a control by the electronic control portion 36 cannot be performed. In other words, the electronic control portion 36 is not operational. However, because the hydraulic pressure in the impeller clutch hydraulic pressure chamber R3 is discharged to the discharge circuit DL via the impeller clutch fluid passage 24 and the fail valve 31 to engage the impeller clutch 13b to establish the engaging state, a vehicle is operable.

Second, in a case where the line pressure linear solenoid valve 37 fails in a state where the hydraulic pressure is not outputted (energized state), the spring 31a of the fail valve 31 is in a compressed state, which corresponds to the normal state that the fluid passage 33 and the impeller clutch fluid passage 24 are connected by the fail valve 31. Accordingly, the electronic control portion 36 enables to control the engagement or disengagement of the impeller clutch 13b by controlling the impeller clutch linear solenoid valve 38b, and a vehicle is operable by the control of the impeller clutch 13b to establish the engaging state.

Third, in a case where the fail valve 31 fails in a state where the spring 31a is compressed, similar to the second case, because the fail valve 31 connects the fluid passage 33 and the impeller clutch fluid passage 24, which corresponds to the normal state, the electronic control portion 36 controls the impeller clutch linear solenoid valve 38b to control the engagement or disengagement of the impeller clutch 13b to engage the impeller clutch 13b to establish the engaging state. Thus, the vehicle is operable.

Fourth, in a case where the fail valve 31 fails in a state where the spring 31a is expanded, similar to the first case, the spring 31a of the fail valve 31 is in an expanded state, and the fail valve 31 connects the discharge circuit DL and the impeller clutch fluid passage 24. Accordingly, a control by the electronic control portion 36 cannot be performed. That is, the electronic control portion 36 is not operational. However, because the hydraulic pressure in the impeller clutch hydraulic pressure chamber R3 is discharged to the discharge circuit DL via the impeller clutch fluid passage 24 and the fail valve 31 to engage the impeller clutch 13b to establish the engaging state, a vehicle is operable.

Fifth, in a case where the impeller clutch linear solenoid valve 38b fails in a state where the impeller clutch linear solenoid valve 38b is controlled to generate the hydraulic pressure (energized state), the following is performed. When detecting a state that the impeller clutch linear solenoid valve 38b outputs the hydraulic pressure, the electronic control portion 36 controls the line pressure linear solenoid valve 37 connected to the fail valve 31 to be in a non-energized state. Accordingly, because the fail valve 31 connects the impeller clutch fluid passage 24 and the discharge circuit DL, and the hydraulic pressure in the impeller clutch hydraulic pressure chamber R3 is discharged to the discharge circuit DL via the impeller clutch fluid passage 24 and the fail valve 31 to engage the impeller clutch 13b to establish the engaging state, the vehicle is operable.

Sixth, in a case where the impeller clutch linear solenoid valve 38b fails in a state where the impeller clutch linear solenoid valve 38b does not generate the hydraulic pressure (non-energized state), irrespective of the operation of the line pressure linear solenoid valve 37 by the electronic control portion 36, the impeller clutch fluid passage 24 is connected to the discharge circuit DL or the impeller clutch linear solenoid valve 38b, which is in a state not to output the hydraulic pressure. Accordingly, the hydraulic pressure is not supplied to the impeller clutch hydraulic pressure chamber R3, the impeller clutch 13b is engaged, and the vehicle is operable.

Seventh, in a case of a failure at which all electronic parts are in a non-energized state, such as a power shut down of the electronic control portion 36, the line pressure linear solenoid valve 37 connected to the fail valve 31 becomes a non-energized state so as to output the maximum hydraulic pressure, and the fail valve 31 connects the impeller clutch fluid passage 24 and the discharge circuit DL to discharge the hydraulic pressure in the impeller clutch hydraulic pressure chamber R3 to the discharge circuit DL via the impeller clutch fluid passage 24 and the fail valve 31 to engage the impeller clutch 13b to establish the engaging state. Accordingly, the vehicle is operable.

According to the construction of the eighth embodiment, likewise the fifth embodiment, because the impeller clutch 13b is securely engaged even if any components of the hydraulic pressure control apparatus fail, the vehicle is prevented from being inoperable, thus the safety of the vehicle is enhanced.

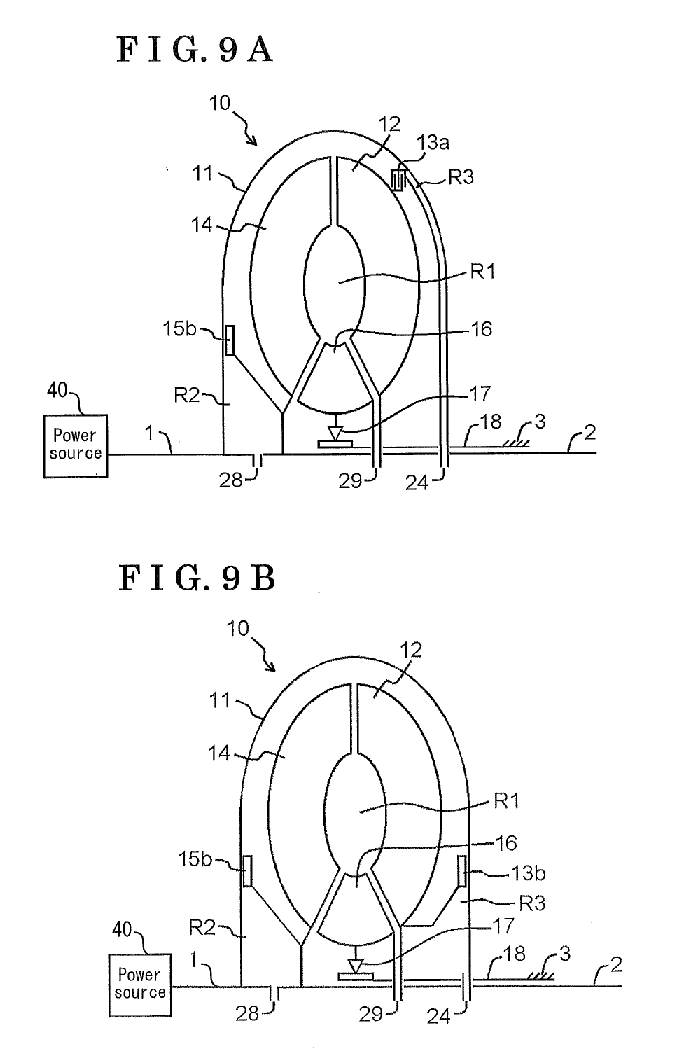

A hydraulic pressure control apparatus for a hydraulic power transmission according to a ninth embodiment will be explained with reference to FIGS. 9A and 9B as follows. The ninth embodiment discloses modified examples of a torque converter applicable to the hydraulic pressure control apparatus for the hydraulic power transmission. FIG. 9A shows a torque converter including a single-plate lock-up clutch and a multi-plate impeller clutch, and FIG. 9B shows a torque converter including a single-plate lock-up clutch and a single-plate impeller clutch.

The first to eighth embodiments disclose the hydraulic pressure control apparatus for the hydraulic power transmission including the multi-plate lock-up clutch (15a in FIGS. 1 to 8). On the other hand, the ninth embodiment discloses the hydraulic power transmission (torque converter 10) which includes a single-plate lock-up clutch 15b which is interchangeably applicable to the hydraulic pressure control apparatus for the hydraulic power transmission of the first to eighth embodiments.

The torque converters 10 disclosed in FIGS. 9A and 9B include the single-plate lock-up clutch 15b which eliminates the rotational speed difference of the turbine runner 14 and the power source (e.g., engine) 40 by directly connecting the pump impeller 12 and the turbine runner 14 when the rotational speed difference between the pump impeller 12 and the turbine runner 14 is small. When the lock-up clutch 15b is engaged with the converter shell 11, a rotational force (torque) of the converter shell 11 is transmitted to the turbine runner 14. The lock-up clutch 15b includes a single-type clutch plate fixed to a member which is configured to integrally rotate with the turbine runner 14. When the hydraulic pressure in the hydraulic power transmission chamber R1 is greater than the hydraulic pressure in the lock-up clutch hydraulic pressure chamber R2, the lock-up clutch 15b establishes an engaged state by pressing the clutch plate to an inner wall surface of the converter shell 11. On the other hand, when the hydraulic pressure in the lock-up clutch hydraulic pressure chamber R2 is greater than the hydraulic pressure in the hydraulic power transmission chamber R1, the lock-up clutch 15b establishes a disengaged state by separating the clutch plate from the converter shell 11. In those circumstances, the hydraulic pressure in the hydraulic power transmission chamber R1 is controlled through a lock-up-on fluid passage 29, and the hydraulic pressure in the lock-up clutch hydraulic pressure chamber R2 is controlled through a lock-up-off fluid passage 28. Other constructions of the ninth embodiment are similar to the constructions of the first to eighth embodiments.

Advantages and effects similar to the first to eighth embodiments are attained according to the ninth embodiment. Further, the control of the lock-up clutch, the fluidic transmission, and the control of the impeller clutch can be performed with three fluid passages in a case where the single-plate lock-up clutch 15b is applied to the hydraulic power transmission, which has the same fluid passage number with the Patent reference 1. Thus, an increase of the number of the parts can be restrained. In a case where the multi-plate lock-up clutch (15a in FIGS. 1 to 8) is applied to the hydraulic power transmission likewise the constructions disclosed in the embodiments 1 to 8, the control of the lock-up clutch, the fluidic transmission, and the control of the impeller clutch are performed with four fluid passages. In this case, the number of components are increased, however, the foregoing construction includes advantages, for example, that the control of the lock-up clutch, the fluidic transmission, and the control of the impeller clutch are securely performed even at states having a higher torque.

According to the embodiment, the hydraulic pressure control apparatus for the hydraulic power transmission includes the first solenoid valve 32 connected to the fail valve 31 for providing the hydraulic pressure to the fail valve 31 when energized and not providing the hydraulic pressure to the fail valve 31 when not energized. The hydraulic pressure chamber R3 is adapted to be connected to the control valve 34, 38a, 38b when the hydraulic pressure is supplied to the fail valve 31 via the first solenoid valve 32 and the hydraulic pressure chamber R3 is adapted to be connected to the source of hydraulic pressure when the hydraulic pressure is not supplied to the fail valve 31 via the first solenoid valve 32. The electronic control portion 36 controls an operation of the first solenoid valve 32 so that the hydraulic pressure chamber R3 is connected to the source of the hydraulic pressure when the control valve 31 fails in a state where the hydraulic pressure is not provided.

Further, according to the embodiment, the hydraulic pressure control apparatus for the hydraulic power transmission includes the second solenoid valve 37 connected to the fail valve 31 for selectively providing a reduced hydraulic pressure, which is controlled in accordance with an amount of energizing current supplied to the second solenoid valve 37, to the fail valve 31 when energized and for providing the hydraulic pressure to the fail valve 31 when not energized. The hydraulic pressure chamber R3 is connected to the source of the hydraulic pressure when the hydraulic pressure is supplied to the fail valve 31 via the second solenoid valve 37 and the hydraulic pressure chamber R3 is connected to control valve 34 when the hydraulic pressure is not supplied to the fail valve 31 via the second solenoid valve 37. The electronic control portion 36 controls an operation of the second solenoid valve 37 so that the hydraulic pressure chamber R3 is connected to the source of the hydraulic pressure when the control valve 34 fails in a state where the hydraulic pressure is not provided.

According to the embodiment, the hydraulic pressure control apparatus for the hydraulic power transmission includes the third solenoid valve 35 connected to the control valve 34 for providing the hydraulic pressure to the control valve 31 when energized and not providing the hydraulic pressure to the control valve 31 when not energized. The fail valve 31 is adapted to be connected to the supply source of the hydraulic pressure when the hydraulic pressure is supplied to the control valve 31 via the third solenoid valve 35, and is adapted to be connected to a discharge passage when the hydraulic pressure is not supplied to the control valve 31 via the third solenoid valve 35. The electronic control portion controls an operation of the third solenoid valve 35 so that the hydraulic pressure chamber R3 is connected to the source of the hydraulic pressure for engaging the impeller clutch 13a.

According to the embodiment, the control valve corresponds to the fourth solenoid valve 38a for selectively providing a reduced hydraulic pressure, which is controlled in accordance with an amount of energizing current supplied to the fourth solenoid valve 38a, to the fail valve 31 when energized and which outputs the hydraulic pressure to the fail valve 31 when not energized; and the electronic control portion controls an operation of the fourth solenoid valve 38a so that the hydraulic pressure is supplied to the hydraulic pressure chamber R3 via the fourth solenoid valve 38a for engaging the impeller clutch 13a.

According to the embodiment, the hydraulic pressure control apparatus for the hydraulic power transmission includes the first solenoid valve 32 connected to the fail valve 31 for providing a hydraulic pressure to the fail valve 31 when energized and configured to connect the fail valve 31 and the discharge passage DL for discharging the hydraulic pressure via the fail valve 31 when not energized. The hydraulic pressure chamber R3 is connected to the control valve 34 when the hydraulic pressure is supplied to the fail valve 31 via the first solenoid valve 32. The electronic control portion 36 controls an operation of the first solenoid valve 32 so that the hydraulic pressure chamber is connected to the discharge passage DL when the control valve fails in a state where the hydraulic pressure is supplied.

According to the embodiment, the hydraulic pressure control apparatus for the hydraulic power transmission includes the second solenoid valve 37 connected to the fail valve 31 for selectively providing a reduced hydraulic pressure, which is controlled in accordance with an amount of energizing current supplied to the second solenoid valve 37, to the fail valve 31 when energized and for providing the hydraulic pressure to the fail valve 31 when not energized. The hydraulic pressure chamber R3 is connected to the discharge passage DL when the hydraulic pressure is supplied to the fail valve 31 via the second solenoid valve 37 and the hydraulic pressure chamber R3 is connected to control valve 34 when the hydraulic pressure is not supplied to the fail valve 31 via the second solenoid valve 37. The electronic control portion 36 controls an operation of the second solenoid valve 37 so that the hydraulic pressure chamber is connected to the discharge passage DL when the control valve 34 fails in a state where the hydraulic pressure is provided.

According to the embodiment, the hydraulic pressure control apparatus for the hydraulic power transmission includes the third solenoid valve 35 connected to the control valve 34 for providing a hydraulic pressure to the control valve 34 when energized and not providing the hydraulic pressure to the control valve 34 when not energized. The fail valve 31 is adapted to be connected to the discharge passage DL when the hydraulic pressure is supplied to the control valve 34 via the third solenoid valve 35, and is adapted to be connected to the source of a hydraulic pressure when the hydraulic pressure is not supplied to the control valve 34 via the third solenoid valve 35. The electronic control portion 36 controls an operation of the third solenoid valve 35 so that the hydraulic pressure chamber R3 is connected to the discharge passage DL for engaging the impeller clutch 13b.

According to the embodiment, the control valve corresponds to the fifth solenoid valve 38b which selectively provides a reduced hydraulic pressure which is controlled in accordance with an amount of energizing current supplied to the fifth solenoid valve 38b and which provides the hydraulic pressure to the fail valve 31 when non-energized; and the electronic control portion 36 controls an operation of the fifth solenoid valve 38b so that the hydraulic pressure is not supplied to the hydraulic pressure chamber R3 via the fifth solenoid valve 38b for engaging the impeller clutch 13b.

According to the embodiment, the hydraulic power transmission includes the multi-plate type lock-up clutch 15a or the single-plate type lock-up clutch 15b which is configured to directly connect the turbine runner 14 and the power source 40.

According to the embodiments, even if any one of the components of the hydraulic pressure control apparatus fails (a failure of the solenoid valve, a failure of the fail valve or the control valve, a failure of the electronic control portion, or the like), the pump impeller and the power source can be securely connected, the vehicle is prevented from being inoperable, and the safety of the vehicle is enhanced.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A hydraulic pressure control apparatus for a hydraulic power transmission, comprising:
the hydraulic power transmission comprising:
a pump impeller configured to rotate;
a turbine runner configured to rotate receiving an operational fluid provided from the rotating pump impeller; and
a multi-plate impeller clutch configured to disconnect the pump impeller from a power source, the multi-plate impeller clutch configured to engage the pump impeller to the power source by supplying a hydraulic pressure to a hydraulic pressure chamber;
a control valve for controlling a level of the hydraulic pressure to be supplied to the hydraulic pressure chamber;
a fail valve disposed between the hydraulic pressure chamber and the control valve, the fail valve for selectively connecting the hydraulic pressure chamber and the control valve or the hydraulic pressure chamber and a source of a hydraulic pressure; and
an electronic control portion controlling operations of the control valve and the fail valve; wherein the hydraulic pressure chamber is connected to the source of the hydraulic pressure when at least one of the control valve, the fail valve, and the electronic control portion fails.

2. The hydraulic pressure control apparatus for the hydraulic power transmission according to claim 1, further comprising:
a first solenoid valve connected to the fail valve for providing a hydraulic pressure to the fail valve when energized and not providing the hydraulic pressure to the fail valve when not energized; wherein
the hydraulic pressure chamber is adapted to be connected to the control valve when the hydraulic pressure is supplied to the fail valve via the first solenoid valve and the hydraulic pressure chamber is adapted to be connected to the source of hydraulic pressure when the hydraulic pressure is not supplied to the fail valve via the first solenoid valve; and wherein
the electronic control portion controls an operation of the first solenoid valve so that the hydraulic pressure chamber is connected to the source of the hydraulic pressure when the control valve fails in a state where the hydraulic pressure is not provided.

3. The hydraulic pressure control apparatus for the hydraulic power transmission according to claim 1, further comprising:
a second solenoid valve connected to the fail valve for selectively providing a reduced hydraulic pressure, which is controlled in accordance with an amount of energizing current supplied to the second solenoid valve, to the fail valve when energized and for providing the hydraulic pressure to the fail valve when not energized; wherein
the hydraulic pressure chamber is connected to the source of the hydraulic pressure when the hydraulic pressure is supplied to the fail valve via the second solenoid valve and the hydraulic pressure chamber is connected to control valve when the hydraulic pressure is not supplied to the fail valve via the second solenoid valve; and wherein
the electronic control portion controls an operation of the second solenoid valve so that the hydraulic pressure chamber is connected to the source of the hydraulic pressure when the control valve fails in a state where the hydraulic pressure is not provided.

4. The hydraulic pressure control apparatus for the hydraulic power transmission according to claim 1, further comprising:
a third solenoid valve connected to the control valve for providing a hydraulic pressure to the control valve when energized and not providing the hydraulic pressure to the control valve when not energized; wherein
the fail valve is adapted to be connected to the supply source of the hydraulic pressure when the hydraulic pressure is supplied to the control valve via the third solenoid valve, and is adapted to be connected to a discharge passage when the hydraulic pressure is not supplied to the control valve via the third solenoid valve; and wherein
the electronic control portion controls an operation of the third solenoid valve so that the hydraulic pressure chamber is connected to the source of the hydraulic pressure for engaging the impeller clutch.

5. The hydraulic pressure control apparatus for the hydraulic power transmission according to claim 1, wherein the control valve corresponds to a fourth solenoid valve for selectively providing a reduced hydraulic pressure, which is controlled in accordance with an amount of energizing current supplied to the fourth solenoid valve, to the fail valve when energized and which outputs the hydraulic pressure to the fail valve when not energized; and the electronic control portion controls an operation of the fourth solenoid valve so that the hydraulic pressure is supplied to the hydraulic pressure chamber via the fourth solenoid valve for engaging the impeller clutch.

6. A hydraulic pressure control apparatus for a hydraulic power transmission, comprising:
the hydraulic power transmission comprising:
a pump impeller configured to rotate;
a turbine runner configured to rotate receiving an operational fluid provided from the rotating pump impeller; and
a single-plate impeller clutch for disconnecting the pump impeller from a power source, the single-plate impeller clutch configured to engage the pump impeller to the power source when a hydraulic pressure in a hydraulic pressure chamber is smaller than a predetermined level;
a control valve for controlling a level of the hydraulic pressure to be supplied to the hydraulic pressure chamber;
a fail valve disposed between the hydraulic pressure chamber and the control valve, the fail valve selectively connecting the hydraulic pressure chamber and the control valve or the hydraulic pressure chamber and a discharge passage; and
an electronic control portion controlling operations of the control valve and the fail valve; wherein
the hydraulic pressure chamber is connected to the discharge passage when at least one of the control valve, the fail valve, and the electronic control portion fails.

7. The hydraulic pressure control apparatus for the hydraulic power transmission according to claim 6, further comprising:
a first solenoid valve connected to the fail valve for providing a hydraulic pressure to the fail valve when energized and configured to connect the fail valve and the discharge passage for discharging the hydraulic pressure via the fail valve when not energized; wherein
the hydraulic pressure chamber is connected to the control valve when the hydraulic pressure is supplied to the fail valve via the first solenoid valve; and wherein
the electronic control portion controls an operation of the first solenoid valve so that the hydraulic pressure chamber is connected to the discharge passage when the control valve fails in a state where the hydraulic pressure is supplied.

8. The hydraulic pressure control apparatus for the hydraulic power transmission according to claim 6, further comprising:
a second solenoid valve connected to the fail valve for selectively providing a reduced hydraulic pressure, which is controlled in accordance with an amount of energizing current supplied to the second solenoid valve, to the fail valve when energized and for providing the hydraulic pressure to the fail valve when not energized; wherein
the hydraulic pressure chamber is connected to the discharge passage when the hydraulic pressure is supplied to the fail valve via the second solenoid valve and the hydraulic pressure chamber is connected to control valve when the hydraulic pressure is not supplied to the fail valve via the second solenoid valve; and wherein
the electronic control portion controls an operation of the second solenoid valve so that the hydraulic pressure chamber is connected to the discharge passage when the control valve fails in a state where the hydraulic pressure is provided.

9. The hydraulic pressure control apparatus for the hydraulic power transmission according to claim 6, further comprising:
a third solenoid valve connected to the control valve for providing a hydraulic pressure to the control valve when energized and not providing the hydraulic pressure to the control valve when not energized; wherein
the fail valve is adapted to be connected to the discharge passage when the hydraulic pressure is supplied to the control valve via the third solenoid valve, and is adapted to be connected to a source of a hydraulic pressure when the hydraulic pressure is not supplied to the control valve via the third solenoid valve; and wherein
the electronic control portion controls an operation of the third solenoid valve so that the hydraulic pressure chamber is connected to the discharge passage for engaging the impeller clutch.

10. The hydraulic pressure control apparatus for the hydraulic power transmission according to claim 6, wherein the control valve corresponds to a fifth solenoid valve which selectively provides a reduced hydraulic pressure which is controlled in accordance with an amount of energizing current supplied to the fifth solenoid valve and which provides the hydraulic pressure to the fail valve when non-energized; and the electronic control portion controls an operation of the fifth solenoid valve so that the hydraulic pressure is not supplied to the hydraulic pressure chamber via the fifth solenoid valve for engaging the impeller clutch.

11. The hydraulic pressure control apparatus for the hydraulic power transmission according to claim 1, wherein the hydraulic power transmission includes a multi-plate type lock-up clutch or a single-plate type lock-up clutch which is configured to directly connect the turbine runner and the power source.

12. The hydraulic pressure control apparatus for the hydraulic power transmission according to claim 2, wherein the hydraulic power transmission includes a multi-plate type lock-up clutch or a single-plate type lock-up clutch which is configured to directly connect the turbine runner and the power source.

13. The hydraulic pressure control apparatus for the hydraulic power transmission according to claim 2, further comprising:
a third solenoid valve connected to the control valve for providing a hydraulic pressure to the control valve when energized and not providing the hydraulic pressure to the control valve when not energized; wherein
the fail valve is adapted to be connected to the supply source of the hydraulic pressure when the hydraulic pressure is supplied to the control valve via the third solenoid valve, and is adapted to be connected to a discharge passage when the hydraulic pressure is not supplied to the control valve via the third solenoid valve; and wherein
the electronic control portion controls an operation of the third solenoid valve so that the hydraulic pressure chamber is connected to the source of the hydraulic pressure for engaging the impeller clutch.

14. The hydraulic pressure control apparatus for the hydraulic power transmission according to claim 3, further comprising:
a third solenoid valve connected to the control valve for providing a hydraulic pressure to the control valve when energized and not providing the hydraulic pressure to the control valve when not energized; wherein
the fail valve is adapted to be connected to the supply source of the hydraulic pressure when the hydraulic pressure is supplied to the control valve via the third solenoid valve, and is adapted to be connected to a discharge passage when the hydraulic pressure is not supplied to the control valve via the third solenoid valve; and wherein
the electronic control portion controls an operation of the third solenoid valve so that the hydraulic pressure chamber is connected to the source of the hydraulic pressure for engaging the impeller clutch.

15. The hydraulic pressure control apparatus for the hydraulic power transmission according to claim 2, wherein the control valve corresponds to a fourth solenoid valve for selectively providing a reduced hydraulic pressure, which is controlled in accordance with an amount of energizing current supplied to the fourth solenoid valve, to the fail valve when energized and which outputs the hydraulic pressure to the fail valve when not energized; and the electronic control portion controls an operation of the fourth solenoid valve so that the hydraulic pressure is supplied to the hydraulic pressure chamber via the fourth solenoid valve for engaging the impeller clutch.

16. The hydraulic pressure control apparatus for the hydraulic power transmission according to claim 3, wherein the control valve corresponds to a fourth solenoid valve for selectively providing a reduced hydraulic pressure, which is controlled in accordance with an amount of energizing current supplied to the fourth solenoid valve, to the fail valve when energized and which outputs the hydraulic pressure to the fail valve when not energized; and the electronic control portion controls an operation of the fourth solenoid valve so that the hydraulic pressure is supplied to the hydraulic pressure chamber via the fourth solenoid valve for engaging the impeller clutch.

17. The hydraulic pressure control apparatus for the hydraulic power transmission according to claim 7, further comprising:
a third solenoid valve connected to the control valve for providing a hydraulic pressure to the control valve when energized and not providing the hydraulic pressure to the control valve when not energized; wherein
the fail valve is adapted to be connected to the discharge passage when the hydraulic pressure is supplied to the control valve via the third solenoid valve, and is adapted to be connected to a source of a hydraulic pressure when the hydraulic pressure is not supplied to the control valve via the third solenoid valve; and wherein
the electronic control portion controls an operation of the third solenoid valve so that the hydraulic pressure chamber is connected to the discharge passage for engaging the impeller clutch.

18. The hydraulic pressure control apparatus for the hydraulic power transmission according to claim 8, further comprising:
a third solenoid valve connected to the control valve for providing a hydraulic pressure to the control valve when energized and not providing the hydraulic pressure to the control valve when not energized; wherein
the fail valve is adapted to be connected to the discharge passage when the hydraulic pressure is supplied to the control valve via the third solenoid valve, and is adapted to be connected to a source of a hydraulic pressure when the hydraulic pressure is not supplied to the control valve via the third solenoid valve; and wherein
the electronic control portion controls an operation of the third solenoid valve so that the hydraulic pressure chamber is connected to the discharge passage for engaging the impeller clutch.

19. The hydraulic pressure control apparatus for the hydraulic power transmission according to claim 7, wherein the control valve corresponds to a fifth solenoid valve which selectively provides a reduced hydraulic pressure which is controlled in accordance with an amount of energizing current supplied to the fifth solenoid valve and which provides the hydraulic pressure to the fail valve when energized; and the electronic control portion controls an operation of the fifth solenoid valve so that the hydraulic pressure is not supplied to the hydraulic pressure chamber via the fifth solenoid valve for engaging the impeller clutch.

20. The hydraulic pressure control apparatus for the hydraulic power transmission according to claim 8, wherein the control valve corresponds to a fifth solenoid valve which selectively provides a reduced hydraulic pressure which is controlled in accordance with an amount of energizing current supplied to the fifth solenoid valve and which provides the hydraulic pressure to the fail valve when energized; and the electronic control portion controls an operation of the fifth solenoid valve so that the hydraulic pressure is not supplied to the hydraulic pressure chamber via the fifth solenoid valve for engaging the impeller clutch.
